(19) United States
(12) Patent Application Publication
(10) Pub. No.: US 2024/0265902 A1
(43) Pub. Date: Aug. 8, 2024

(54) SOUND PROCESSING METHOD, SOUND PROCESSING SYSTEM, AND RECORDING MEDIUM

(71) Applicant: YAMAHA CORPORATION, Hamamatsu-shi (JP)

(72) Inventor: Ryunosuke DAIDO, Hamamatsu-shi (JP)

(21) Appl. No.: 18/636,680

(22) Filed: Apr. 16, 2024

Related U.S. Application Data
(63) Continuation of application No. PCT/JP2022/038606, filed on Oct. 17, 2022.

(30) Foreign Application Priority Data
Oct. 18, 2021 (JP) 2021-170511

(51) Int. Cl. G10H 7/00; G10H 1/057

(52) U.S. Cl. CPC G10H 7/002; G10H 1/0575; G10H 2250/031

(57) ABSTRACT

A sound processing method includes: generating with a trained generative model, for each of a plurality of time points including a first time point, a first acoustic feature amount of a target sound to be generated, by sequentially processing input data including condition data representing conditions of the target sound; generating, for each of the plurality of time points, a time-domain waveform signal representing a waveform of the target sound based on the first acoustic feature amount; and generating, for each of the plurality of time points, a second acoustic feature amount based on the time-domain waveform signal. The input data at the first time point includes the second acoustic feature amount generated before the first time point.

### CROSS REFERENCE TO RELATED APPLICATIONS

This application is a Continuation Application of PCT Application No. PCT/JP2022/038606, filed on Oct. 17, 2022, and is based on and claims priority from Japanese Patent Application No. 2021-170511, filed Oct. 18, 2021, the entire contents of each of which are incorporated herein by reference.

### TECHNICAL FIELD

The present disclosure relates to sound processing.

### BACKGROUND

There have been proposed a variety of techniques for generating a desired sound (hereinafter, “target sound”). For example, “A NEURAL PARAMETRIC SINGING SYNTHESIZER” (Merlijn Blaauw and Jordi Bonada, arXiv preprint arXiv: 1704.03809v3 (2017)) discloses a technique of generating a waveform signal of a target sound using a trained generative model. The generative model in the technique described in “A NEURAL PARAMETRIC SINGING SYNTHESIZER” generates acoustic features of a target sound in a frequency domain. The acoustic features are converted into a time-domain waveform signal. The acoustic features generated by the generative model are returned to the input side of the generative model. That is, the acoustic features generated in the past are used for current generation of acoustic features by the generative model.

Processing for generating a waveform signal from acoustic features is associated with a variety of fluctuations. For example, in a case that a waveform signal is generated by probabilistic processing using a random number, an audio property of the waveform signal fluctuates in accordance with the random number. By way of a further example, in a case that the acoustic features are adjusted in accordance with an instruction from a user, the audio property of the waveform signal fluctuates in accordance with the instruction from the user. In the technique used in “A NEURAL PARAMETRIC SINGING SYNTHESIZER” referred to above, acoustic features immediately after being generated by a generative model are returned to the input side of the generative model. That is, the acoustic features returned to the generative model do not reflect the fluctuations described above. Consequently, generation of a perceptually natural target sound is subject to limitations.

### SUMMARY

Given the above circumstances, one aspect of the present disclosure is to generate a waveform signal of a target sound that is perceptually natural as sound.

In order to solve the above problem, a sound processing method according to one aspect of the present disclosure includes: generating with a trained generative model, for each of a plurality of time points including a first time point, a first acoustic feature amount of a target sound to be generated, by sequentially processing input data including condition data representing conditions of the target sound; generating, for each of the plurality of time points, a time-domain waveform signal representing a waveform of the target sound based on the first acoustic feature amount; and generating, for each of the plurality of time points, a second acoustic feature amount based on the time-domain waveform signal, in which the input data at the first time point includes the second acoustic feature amount generated before the first time point.

A sound processing system according to another aspect of the present disclosure includes: one or more memories storing instructions; and one or more processors configured to execute the stored instructions to: generate with a trained generative model, for each of a plurality of time points including a first time point, a first acoustic feature amount of a target sound to be generated, by sequentially processing input data including condition data representing conditions of the target sound; generate, for each of the plurality of time points, a time-domain waveform signal representing a waveform of the target sound based on the first acoustic feature amount; and generate, for each of the plurality of time points, a second acoustic feature amount based on the time-domain waveform signal, in which the input data at the first time point includes the second acoustic feature amount generated before the first time point.

A recording medium according to another aspect of the present disclosure is a non-transitory computer-readable recording medium storing instructions executable by a processor to perform a method including: generating with a trained generative model, for each of a plurality of time points including a first time point, a first acoustic feature amount of a target sound to be generated, by sequentially processing input data including condition data representing conditions of the target sound; generating, for each of the plurality of time points, a time-domain waveform signal representing a waveform of the target sound based on the first acoustic feature amount; and generating, for each of the plurality of time points, a second acoustic feature amount based on the time-domain waveform signal, in which the input data at the first time point includes the second acoustic feature amount generated before the first time point.

### BRIEF DESCRIPTION OF THE DRAWINGS

FIG. 1 is a block diagram illustrating a configuration of a sound processing system according to a first embodiment;

FIG. 2 is a block diagram illustrating a functional configuration of the sound processing system;

FIG. 3 is an explanatory diagram of processing performed by a sound processor;

FIG. 4 is a block diagram illustrating a detailed configuration of a harmonic signal generator;

FIG. 5 is an explanatory diagram of processing for changing a harmonic spectral envelope;

FIG. 6 is a block diagram illustrating a detailed configuration of an inharmonic signal generator;

FIG. 7 is a block diagram illustrating a detailed configuration of a modulation signal generator;

FIG. 8 is a diagram illustrating frequency characteristics of a basic modulation signal;

FIG. 9 is a flowchart illustrating a detailed procedure of waveform generation processing;

FIG. 10 is a block diagram illustrating a functional configuration relating to first learning processing;

FIG. 11 is a block diagram illustrating a functional configuration relating to second learning processing;

FIG. 12 is a flowchart illustrating a detailed procedure of first learning processing;

FIG. 13 is a flowchart illustrating a detailed procedure of second learning processing;

FIG. 14 is a block diagram illustrating a functional configuration relating to machine learning processing according to a modification;

FIG. 15 is a block diagram illustrating a functional configuration of a sound processing system according to a second embodiment;

FIG. 16 is a block diagram illustrating a detailed configuration of a harmonic signal generator according to the second embodiment;

FIG. 17 is a block diagram illustrating a functional configuration of a sound processing system according to a third embodiment; and

FIG. 18 is a flowchart illustrating a detailed procedure of waveform generation processing of a third embodiment.

### DESCRIPTION OF THE EMBODIMENTS

### A: First Embodiment

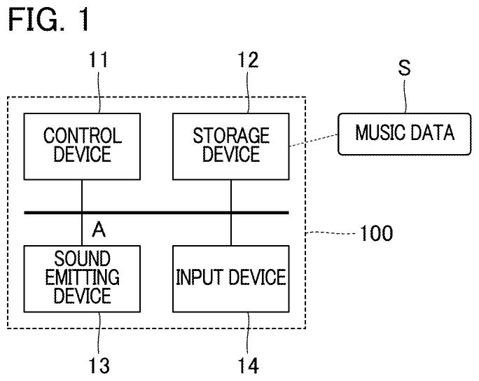

FIG. 1 is a block diagram illustrating a configuration of a sound processing system 100 according to a first embodiment. The sound processing system 100 is a computer system that generates a target sound. The target sound is a sound generated by the sound processing system 100. The target sound is, for example, a singing voice sound produced by a singer or an instrumental sound produced by a musical instrument.

The sound processing system 100 includes a control device 11, a storage device 12, a sound emitting device 13, and an input device 14. The sound processing system 100 is for example, an information apparatus such as a smartphone, a tablet, or a personal computer. The sound processing system 100 need not be a single device and can be constituted of multiple independent devices.

The control device 11 is constituted of one or more processors that control the elements of the sound processing system 100. For example, the control device 11 is constituted of one or more types of processors such as a central processing unit (CPU), a sound processing unit (SPU), a digital signal processor (DSP), a field programmable gate array (FPGA), or an application specific integrated circuit (ASIC). The control device 11 generates, for example, an audio signal A representative of a waveform of a target sound.

The storage device 12 comprises one or more memories that store programs to be executed by the control device 11 and various types of data to be used by the control device 11. The storage device 12 is constituted of, for example, a known recording medium such as a magnetic recording medium or a semiconductor recording medium, or a combination of different types of recording media. A portable recording medium that is detachable from the sound processing system 100, or a recording medium (for example, cloud storage) by which the control device 11 can perform writing or reading via a communication network can be used as the storage device 12.

The storage device 12 stores music data S that represents a piece of music. The music data S specifies a pitch and a sound period of each of a plurality of notes constituting the piece of music. When the target sound is a singing voice sound, the music data S specifies a phonetic symbol for each of the plurality of notes in addition to the pitch and the sound period. The music data S may specify information such as musical symbols that represent musical expressions.

The input device 14 is an input device that receives instructions from a user. The input device 14 is, for example, an operator that is operated by a user or a touchscreen that detects contact by a user. The input device 14 (for example, a mouse or a keyboard) is separate from the sound processing system 100 and connected either by wire or wirelessly to the sound processing system 100.

The sound emitting device 13 reproduces the target sound represented by the audio signal A. The sound emitting device 13 is, for example, a speaker or headphones. Illustrations of a D/A converter that converts the audio signal A from digital to analog form and an amplifier that amplifies the audio signal A are omitted for convenience. The sound emitting device 13 is separate from the sound processing system 100 and is connected to the sound processing system 100 either by wire or wirelessly.

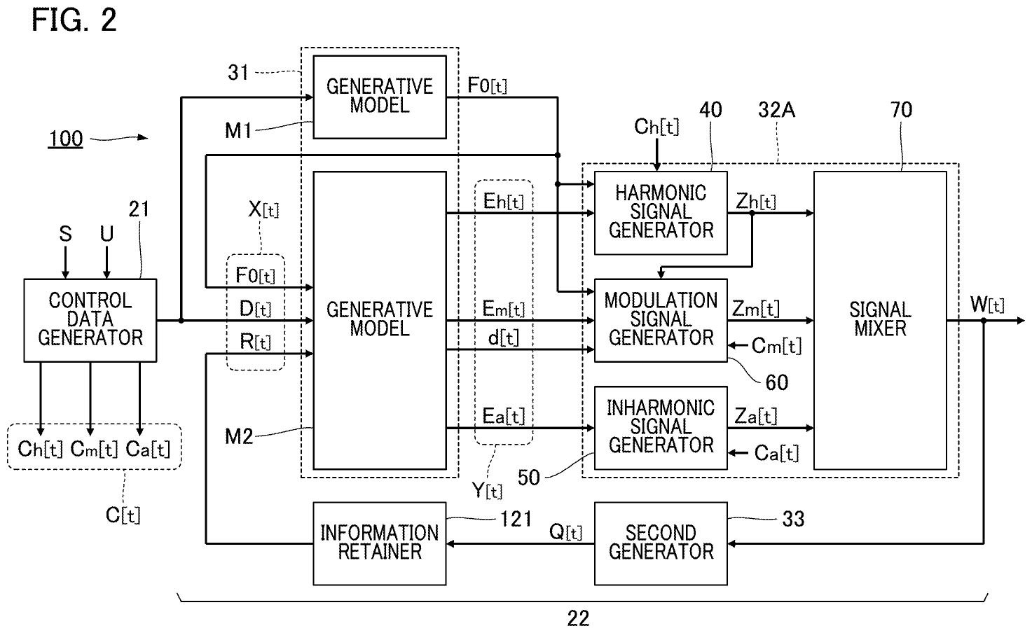

FIG. 2 is a block diagram illustrating a functional configuration of the sound processing system 100. The control device 11 realizes a plurality of functions (a control data generator 21<opt> and a sound processor 22) to generate the audio signal A by executing the programs stored in the storage device 12.

Instruction data U is supplied to the control data generator 21<opt>. The instruction data U represents an instruction from a user to the input device 14. Specifically, the instruction data U represents an instruction relating to a target sound from the user. For example, a volume of the target sound, modulation (change of key) relating to the target sound, a virtual person who produces the target sound, or a sound producing method for the target sound are specified by the instruction data U. The virtual person who produces the target sound is, for example, a singer or a musical instrumentalist. The sound producing method for the target sound is, for example, a singing technique or a playing technique.

The control data generator 21<opt> generates condition data D[t] and control data C[t]<opt> (Ch[t]<opt>, Ca[t]<opt>, and Cm[t]<opt>) in accordance with the music data S and the instruction data U. The condition data D[t] and the control data C[t]<opt> are sequentially generated in each of a plurality of unit periods on a time axis. Reference sign t is a variable indicating one unit period on the time axis. Each unit period has a predetermined length. Specifically, each unit period is set to be a time length sufficiently shorter than a time length of a sound period specified by the music data S for each of a note. Previous and following unit periods on the time axis may partially overlap each other. The control data C[t]<opt> is optional data for controlling audio properties of the target sound. Details of the control data C[t]<opt> will be described later. Hereinafter, data, elements, or steps that are optional are designated as “<opt>”. Optional data, elements, or steps may be omitted from the embodiments of the present disclosure.

The condition data D[t] represents conditions of a target sound. Specifically, the condition data D[t] includes information relating to each note that is representative of the target sound, identification information of a person who produces the sound, and identification information of a sound producing method. The information relating to each note that is representative of the target sound includes, for example, a pitch or volume of each note, and information relating to previous and following notes. Accordingly, the condition data D[t] can be restated as a feature amount (score feature amount) relating to a score of a piece of music represented by the music data S. The identification information of the person who produces sound is information that identifies the person. The identification information of the person who produces sound is expressed by, for example, an embedding vector set in a multidimensional virtual space. The virtual space is a continuous space in which a position of each person who produces sound is determined dependent on a feature of the sound produced by the person. Thus, the closer features of sounds that resemble each other, the closer pieces of identification information of persons who produce the sounds are positioned on coordinates in the virtual space. The identification information of a sound producing method is information for identifying the sound producing method. Similarly to the identification information of a person who produces sound, the identification information of a sound producing method is expressed by, for example, an embedding vector set in a multidimensional virtual space. The virtual space is a continuous space in which the position of the sound producing method is determined according to the feature of the sound produced by the sound producing method. That is, the closer features of sounds, the closer pieces of identification information of the sound producing methods are positioned on coordinates in the virtual space.

The control data generator 21<opt> generates the condition data D[t] and the control data C[t]<opt> by performing predetermined arithmetic processing on the music data S and the instruction data U. The control data generator 21<opt> generates the condition data D[t] and the control data C[t]<opt> using a generative model such as a deep neural network (DNN). The generative model is a statistical estimation model that learns by machine learning a relation between (i) input data including the music data S and the instruction data U, and (ii) output data including the condition data D[t] and the control data C[t]<opt>.

The sound processor 22 generates a waveform signal W[t] in accordance with the condition data D[t] and the control data C[t]<opt> (Ch[t]<opt>, Ca[t]<opt>, and Cm[t]<opt>). The waveform signal W[t] is generated for each unit period. The waveform signal W[t] is a time-domain signal representing the waveform of a target sound. Specifically, the waveform signal W[t] of each unit period is constituted of a time series of samples in a unit period of the audio signal A. That is, the audio signal A is generated by coupling multiple waveform signals W[t] on the time axis. The control data C[t] is optional and a part of or all of the control data C[t] may or may not be used for generating the waveform signal W[t].

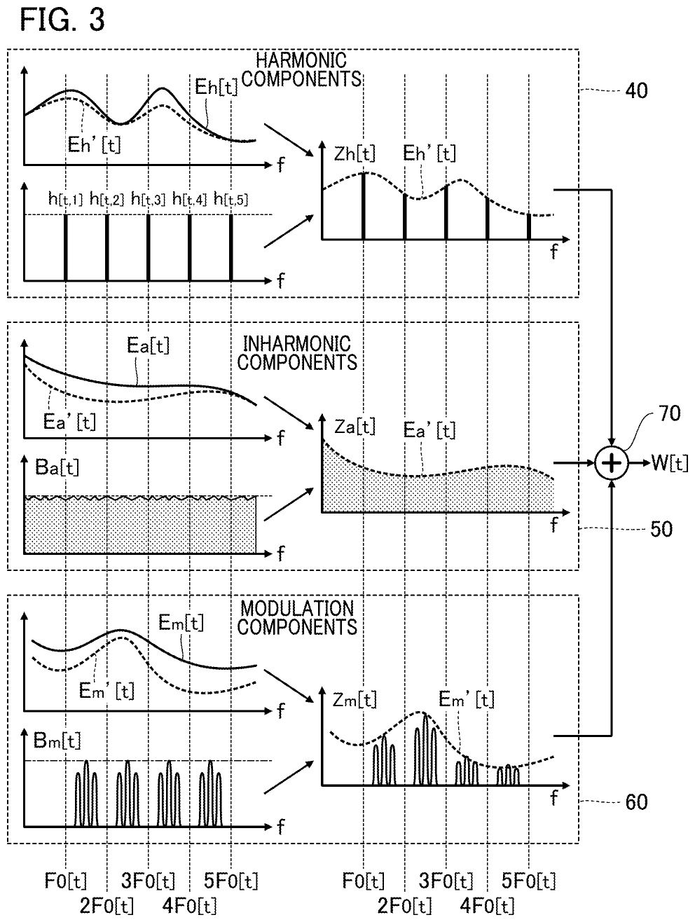

FIG. 3 is an explanatory diagram of processing performed by the sound processor 22. Reference sign f in FIG. 3 denotes a frequency. A target sound includes harmonic components, inharmonic components, and modulation components. The harmonic components comprise periodic audio components composed of a fundamental component and a plurality of overtone components. The fundamental component is an audio component that has a fundamental frequency F0[t]. Each of the overtone components is an audio component that has an overtone frequency n F0[t], which is an integer multiple of the fundamental frequency F0[t]. The inharmonic components are non-periodic noise components occurring over a wide range of a frequency domain. The inharmonic components contribute to a breathiness of the target sound. The modulation components are characteristic audio components such as growl produced by vibration of vestibular folds or false vocal cords. The harmonic components and the modulation components are dependent on the fundamental frequency F0[t].

As illustrated in FIG. 2, the control data C[t]<opt> includes harmonic control data Ch[t]<opt>, inharmonic control data Ca[t]<opt>, and modulation control data Cm[t]<opt>. The harmonic control data Ch[t]<opt> is data for controlling the harmonic components of the target sound. The inharmonic control data Ca[t]<opt> is data for controlling the inharmonic components of the target sound. The modulation control data Cm[t]<opt> is data for controlling the modulation components of the target sound. The control data C[t]<opt> contains at least one of the harmonic control data Ch[t]<opt>, the inharmonic control data Ca[t]<opt>, or the modulation control data Cm[t]<opt>.

The sound processor 22 includes a first generator 31, a signal generator 32A, and a second generator 33. The first generator 31 sequentially generates for each unit period a fundamental frequency F0[t], a frequency characteristic E[t] and a modulation degree d[t]<opt>. As described above, the fundamental frequency F0[t] is the frequency of the fundamental component of the harmonic components of the target sound. Therefore, the fundamental frequency F0[t] is referred to as “the fundamental frequency F0[t] of the target sound.” The modulation degree d[t]<opt> is optional and may or may not be generated.

The first generator 31 generates the fundamental frequency F0[t] of the target sound from the condition data D[t] of the target sound. The first generator 31 utilizes a generative model M1 to generate the fundamental frequency F0[t]. The generative model M1 is a statistical estimation model that learns by machine learning a relation between the condition data D[t] and the fundamental frequency F0[t]. That is, the generative model M1 outputs a fundamental frequency F0[t] that is statistically adequate for the condition data D[t]. Specifically, the generative model M1 is realized by a combination of a program for causing the control device 11 to execute an operation to generate a fundamental frequency F0[t] from condition data D[t] and a plurality of variables to be applied to the operation. The value of each of the plurality of variables is established in advance by machine learning. The first generator 31 generates the fundamental frequency F0[t] of a target sound by inputting the condition data D[t] to the generative model M1.

The generative model M1 is constituted of, for example, a DNN. Any form of DNN such as a recurrent neural network (RNN) or a convolutional neural network (CNN) can be used as the generative model M1. The generative model M1 may be constituted of a combination of different types of DNNs. An additional element such as a long short-term memory (LSTM) or Attention may be loaded in the generative model M1.

The frequency characteristics E[t] are acoustic features of the target sound expressed in the frequency domain. Specifically, a frequency characteristic E[t] represents the frequency spectrum of the target sound and includes a harmonic spectral envelope Eh[t], an inharmonic spectral envelope Ea[t], and a modulation spectral envelope Em[t]<opt>. The harmonic spectral envelope Eh[t] is a contour or a shape of the intensity spectrum of the harmonic components of the target sound. The inharmonic spectral envelope Ea[t] is a contour or a shape of the intensity spectrum of the inharmonic components of the target sound. Similarly, the modulation spectral envelope Em[t]<opt> is a contour or a shape of the intensity spectrum of the modulation components of the target sound. The intensity spectrum is an amplitude spectrum or a power spectrum. Each of the harmonic spectral envelope Eh[t], the inharmonic spectral envelope Ea[t], and the modulation spectral envelope Em[t]<opt> is expressed in, for example, a form such as Mel frequency spectral coefficients (MFSCs). The frequency characteristic E[t] is one example of a “first acoustic feature amount.” The modulation degree d[t]<opt> is a variable for controlling the modulation component of the target sound. Details of the modulation degree d[t]<opt> will be described later. The modulation spectral envelope Em[t]<opt> is optional and may be omitted from the frequency characteristic E[t].

The first generator 31 generates output data Y[t] from input data X[t] for each unit period. The input data X[t] includes the condition data D[t] and the fundamental frequency F0[t] of a target sound, and return data R[t]<opt>. The return data R[t]<opt> of each unit period represents the audio property of a waveform signal W[t] generated prior to a unit period. Details of the return data R[t]<opt> will be described later. The output data Y[t] includes at least the frequency characteristic E[t], and further includes the modulation degree d[t]<opt> in a case in which the frequency characteristic E[t] includes the modulation spectral envelope Em[t]<opt>.

The first generator 31 utilizes an auto-regressive generative model M2 to generate the output data Y[t]. The generative model M2 is a statistical estimation model that learns by machine learning a relation between the input data X[t] and the output data Y[t]. The generative model M2 outputs the output data Y[t] as statistically adequate for the input data X[t]. Specifically, the generative model M2 is realized by a combination of a program that causes the control device 11 to execute an operation for generating output data Y[t] from input data X[t], and a plurality of variables applied to the operation. The value of each of the plurality of variables is established in advance by machine learning. As will be understood from the above explanation, the first generator 31 sequentially generates a frequency characteristic E[t] and a modulation degree d[t]<opt> of the target sound by sequentially processing input data X[t] with the generative model M2.

The generative model M2 is constituted of, for example, a DNN. For example, any form of a DNN such as an RNN or a CNN can be used as the generative model M2. The generative model M2 may be constituted of a combination of different types of DNNs. An additional element such as the LSTM or Attention may be loaded in the generative model M2.

The signal generator 32A sequentially generates a waveform signal W[t] in accordance with the fundamental frequency F0[t], the output data Y[t] (the frequency characteristic E[t] and the modulation degree d[t]<opt>), and the control data C[t]<opt> (Ch[t]<opt>, Ca[t]<opt>, and Cm[t]<opt>). As described above, the waveform signal W[t] is generated for each unit period. The signal generator 32A includes a harmonic signal generator 40, an inharmonic signal generator 50, a modulation signal generator 60<opt>, and a signal mixer 70.

The harmonic signal generator 40 generates a harmonic signal Zh[t] in accordance with the fundamental frequency F0[t], the harmonic spectral envelope Eh[t], and the harmonic control data Ch[t]<opt>. The harmonic signal generator 40 generates the harmonic signal Zh[t] for each unit period. The harmonic signal Zh[t] is a time-domain signal representing the harmonic components of the target sound.

The inharmonic signal generator 50 generates an inharmonic signal Za[t] in accordance with the inharmonic spectral envelope Ea[t] and the inharmonic control data Ca[t]<opt>. The inharmonic signal generator 50 generates the inharmonic signal Za[t] for each unit period. The inharmonic signal Za[t] is a time-domain signal representing the inharmonic components of the target sound.

The modulation signal generator 60<opt> generates a modulation signal Zm[t]<opt> in accordance with the fundamental frequency F0[t], the modulation spectral envelope Em[t]<opt>, the modulation degree d[t]<opt>, and the modulation control data Cm[t]<opt>. The modulation signal generator 60<opt> generates the modulation signal Zm[t]<opt> for each unit period. The modulation signal Zm[t]<opt> is a time-domain signal representing the modulation components of the target sound. The modulation signal generator 60<opt> may be omitted from the sound processor 22 (or the signal generator 32A). In a case in which the modulation signal generator 60<opt> is omitted, the modulation signal Zm[t]<opt> is not generated.

The signal mixer 70 generates a waveform signal W[t] based on the harmonic signal Zh[t], the inharmonic signal Za[t], and the modulation signal Zm[t]<opt>. Specifically, the signal mixer 70 generates the waveform signal W[t] by mixing the harmonic signal Zh[t], the inharmonic signal Za[t], and the modulation signal Zm[t]<opt>. The signal mixer 70 generates the waveform signal W[t] using the weighted sum of the harmonic signal Zh[t], the inharmonic signal Za[t], and the modulation signal Zm[t]<opt>. A time series of the waveform signals W[t] sequentially generated by the signal mixer 70 is supplied as an audio signal A to the sound emitting device 13. In a case in which the modulation signal Zm[t]<opt> is not generated, the waveform signal W[t] is generated by mixing the harmonic signal Zh[t] and the inharmonic signal Za[t].

The waveform signal W[t] is also supplied to the second generator 33 in addition to the sound emitting device 13. The second generator 33 generates a frequency characteristic Q[t] from the waveform signal W[t]. The second generator 33 generates a frequency characteristic Q[t] for each unit period. The frequency characteristic Q[t] is an acoustic feature amount representative of a feature of the frequency spectrum of the waveform signal W[t] of a target sound. For example, the frequency characteristic Q[t] comprises an acoustic feature amount of the waveform signal W[t] in a form of the MFSCs, Mel-Frequency Cepstrum Coefficients (MFCCs), the amplitude spectrum, the power spectrum, or other similar format. Frequency analysis such as short-time Fourier transform is used for generating the frequency characteristic Q[t]. The frequency characteristic Q[t] of the waveform signal W[t] is one example of a “second acoustic feature amount.” The frequency characteristic Q[t] (the second acoustic feature amount) and the frequency characteristic E[t] (the first acoustic feature amount) each represent the frequency characteristic and can be of either the same form or of different forms.

The sound processor 22 further includes an information retainer 121. The information retainer 121 is a buffer constituted of a part of the storage area of the storage device 12. The information retainer 121 retains the latest P frequency characteristics Q[t] (P is a natural number equal to or more than one). Specifically, the information retainer 121 retains P frequency characteristics Q[t-1] to Q[t-P] generated before the current unit period corresponding to the condition data D[t]. The current unit period denoted by the reference sign t is one example of a “first time point.” The “plurality of unit periods” is one example of the “plurality of time points.” Accordingly, a “unit period of the plurality of unit periods” is one example of the “first time point of the plurality of time points.”

Since the generative model M2 is an auto-regressive model, the input data X[t] of each unit period contains the P frequency characteristics Q[t-1] to Q[t-P] retained by the information retainer 121 as the return data R[t]<opt>. That is, the input data X[t] of one unit period (the first time point) includes the P frequency characteristics Q[t-1] to Q[t-P] (the return data R[t]<opt>) generated before a current unit period, in addition to the fundamental frequency F0[t] and the condition data D[t] of the unit period. The return data R[t]<opt> may comprise only one (P=1) frequency characteristic Q[t-1].

As described above, in the first embodiment, the time-domain waveform signal W[t] is generated from the frequency characteristic E[t] generated by the generative model M2. The frequency characteristics Q[t-1] to Q[t-P] of the waveform signals W[t] are returned as the return data R[t]<opt> to the input side of the generative model M2. That is, fluctuations associated with the processing performed by the signal generator 32A to generate the waveform signal W[t] from the frequency characteristic E[t] are reflected in the frequency characteristics Q[t-1] to Q[t-P] used for generating the frequency characteristic E[t] by the generative model M2. As a result, a waveform signal W[t] of the target sound that is perceptually more natural as audio can be generated as compared with a configuration in which the frequency characteristic E[t] is directly returned to the input side of the generative model M2.

### Harmonic Signal Generator 40

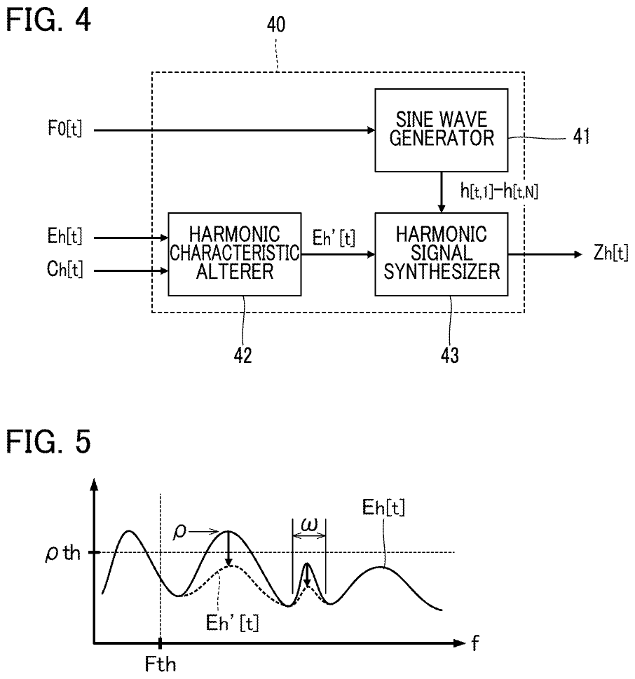

FIG. 4 is a block diagram illustrating a detailed configuration of the harmonic signal generator 40. The harmonic signal generator 40 includes a sine wave generator 41, a harmonic characteristic alterer 42<opt>, and a harmonic signal synthesizer 43.

The sine wave generator 41 generates N sine waves h[t, 1] to h[t,N] for each unit period. Each since wave h[t,n] (n=1 to N) is a time-domain signal. In FIG. 3 for sake of explanation there are illustrated intensity spectra of the N sine waves h[t,1] to h[t,N]. The N sine waves h[t, 1] to h[t,N] are audio components of different harmonic frequencies n·F0[t] corresponding to integer multiples of the fundamental frequency F0[t]. Specifically, the sine wave h[t,1] is a fundamental component of the fundamental frequency F0[t], and the sine waves h[t,2] to h[t,N] are overtone components within overtone frequencies n·F0[t] corresponding to n times the height of the fundamental frequency F0[t]. The levels (for example, the amplitude or power) of the N sine waves h[t,1] to h[t,N] are set in common at a predetermined value (for example, one). As explained above, the sine wave generator 41 generates the N sine waves h[t,1] to h[t,N] in the time domain corresponding to the different harmonic frequencies n·F0[t].

A user can instruct alteration of the harmonic component of the target sound by operating the input device 14. Specifically, the user can instruct alteration of an audio component within the harmonic components of the target sound that may otherwise be perceived as unpleasant. The instruction data U described above includes an instruction on whether to make an alteration to the harmonic components. The control data generator 21<opt> generates for each unit period harmonic control data Ch[t]<opt> indicating whether to make an alteration to the harmonic components in accordance with the instruction data U. The harmonic control data Ch[t]<opt> described above is supplied to the harmonic signal generator 40. The harmonic control data Ch[t]<opt> is optional and the harmonic control data Ch[t]<opt> may or may not be generated.

The harmonic characteristic alterer 42<opt> generates a harmonic spectral envelope Eh′[t] by altering the shape of the harmonic spectral envelope Eh[t]. Specifically, the harmonic characteristic alterer 42<opt> receives the harmonic control data Ch[t]<opt> from the control data generator 21<opt> and alters the harmonic spectral envelope Eh[t] in accordance with the harmonic control data Ch[t]<opt>. As will be understood from the above explanation, the harmonic control data Ch[t]<opt> indicates an alteration to the harmonic spectral envelope Eh[t]. The harmonic control data Ch[t]<opt> of the first embodiment indicates whether to make an alteration to the harmonic spectral envelope Eh[t]. When maintaining (non-alteration) the harmonic spectral envelope Eh[t] is indicated by the harmonic control data Ch[t]<opt>, the harmonic characteristic alterer 42<opt> sets the harmonic spectral envelope Eh[t] as the harmonic spectral envelope Eh′[t]. That is, the harmonic spectral envelope Eh[t] is maintained. When an alteration to the harmonic spectral envelope Eh[t] is indicated by the harmonic control data Ch[t]<opt>, the harmonic characteristic alterer 42<opt> generates the harmonic spectral envelope Eh′[t] by altering the harmonic spectral envelope Eh[t]. As will be understood from the above explanation, the harmonic characteristic alterer 42<opt> alters the harmonic spectral envelope Eh[t] in accordance with an instruction from a user. When the harmonic control data Ch[t]<opt> is not generated, the harmonic characteristic alterer 42<opt> is omitted and the harmonic spectral envelope Eh[t] is used as the harmonic spectral envelope Eh′[t] without having its shape altered.

FIG. 5 is an explanatory diagram of processing performed by the harmonic characteristic alterer 42<opt> to alter the harmonic spectral envelope Eh[t]. The harmonic characteristic alterer 42<opt> generates the harmonic spectral envelope Eh′[t] by suppressing one or more peaks (hereinafter, “target peaks”) that satisfy predetermined conditions (hereinafter, “suppressing conditions”) among the plurality of peaks of the harmonic spectral envelope Eh[t]. The suppressing conditions include a first condition and a second condition.

The first condition is that a maximum value (a peak value) p in a frequency band exceeding a predetermined frequency Fth is above a predetermined threshold ρth. The frequency Fth is set as 2 kHz, for example. The threshold ρth is set as a predetermined value (for example, −60 dB). The second condition is that a peak width ω in the frequency band exceeding the frequency Fth is below a predetermined threshold ωth. The peak width w is, for example, a half bandwidth and the threshold ωth is set as a predetermined positive number. The harmonic characteristic alterer 42<opt> selects as the target peak a peak that satisfies both the first condition and the second condition from among the plurality of peaks of the harmonic spectral envelope Eh[t]. A peak that satisfies either the first condition or the second condition may be selected as the target peak. As will be understood from the above explanation, peaks in a frequency band below the frequency Fth on the frequency axis are not targets for the suppression regardless of the peak values p and the peak widths w. However, the limitation that the target peaks are within the frequency band exceeding the predetermined frequency Fth may be omitted from the first condition and the second condition.

The harmonic characteristic alterer 42<opt> suppresses the target peak in accordance with an adjustment value α. The adjustment value α is a positive number less than one and is set as ½, for example. The harmonic characteristic alterer 42<opt> suppresses the target peak by multiplying the peak value ρ of the target peak by the adjustment value α. For example, in a mode in which the adjustment value α is set to be ½, the target peak is suppressed to have a half (ρ/2) of the peak value ρ, which is a value before changed. The specific value of the adjustment value α is not limited to the above example.

The harmonic signal synthesizer 43 in FIG. 4 generates the harmonic signal Zh[t] in accordance with the harmonic spectral envelope Eh′[t] and the N sine waves h[t,1] to h[t,N]. FIG. 3 illustrates an intensity spectrum of the harmonic signal Zh[t] by way of explanation. The harmonic signal synthesizer 43 changes the levels of the N sine waves h[t,1] to h[t,N] in accordance with the harmonic spectral envelope Eh′[t] and synthesizes the changed N sine waves h[t,1] to h[t,N], to generate the harmonic signal Zh[t]. Specifically, the harmonic signal synthesizer 43 processes the sine waves h[t,n] so that the levels of N sine waves h[t,1] to h[t,N] follow the harmonic spectral envelope Eh′[t]. That is, the level of each sine wave h[t,n] is changed to the respective component value of the harmonic spectral envelope Eh′[t] corresponding to the harmonic frequency n·F0[t] on the frequency axis. The harmonic signal synthesizer 43 then adds the changed N sine waves h[t,1] to h[t,N] described above to generate the harmonic signal Zh[t]. As illustrated above, according to the first embodiment, the harmonic signal Zh[t] can be easily generated by the time-domain processing in which the respective sine wave h[t,n] is processed using the harmonic spectral envelope Eh[t].

The configuration and processing of the harmonic signal synthesizer 40 to generate the harmonic signal Zh[t] are as described above. In the first embodiment, the harmonic spectral envelope Eh[t] is altered in accordance with the harmonic control data Ch[t]<opt>. Specifically, the level of each of the N sine waves h[t,1] to h[t,N] is changed in accordance with the harmonic control data Ch[t]<opt>. Therefore, the harmonic signal Zh[t] having diverse audio properties can be generated, as compared with a configuration in which the harmonic spectral envelope Eh[t] (and therefore the N sine waves h[t,1] to h[t,N]) is not altered. That is, the audio properties of the harmonic components of the target sound can be diversified. Furthermore, the harmonic signal Zh[t] is generated using the altered harmonic spectral envelope Eh′[t] in accordance with the harmonic control data Ch[t]<opt>, and the frequency characteristic Q[t] of the waveform signal W[t] generated from the harmonic signal Zh[t] is returned to the input side of the generative model M2. That is, an alteration to the harmonic spectral envelope Eh[t] in accordance with the harmonic control data Ch[t]<opt> is reflected in the generation of the frequency characteristic E[t] by the generative model M2. Accordingly, it is possible to generate the waveform signal W[t] of the target sound including a harmonic component that is perceptually more natural as audio, as compared with a configuration in which the frequency characteristic E[t] is directly returned to the input side of the generative model M2. As will be understood from the above explanation, an alteration to the harmonic spectral envelope Eh[t] in accordance with the harmonic control data Ch[t]<opt> is one example of fluctuation factors relating to the processing performed by the signal generator 32A to generate the waveform signal W[t] from the frequency characteristic E[t].

Furthermore, in the first embodiment, excessively large or excessively steep peaks among the plurality of peaks of the harmonic spectral envelop Eh[t] are suppressed. Therefore, a waveform signal W[t] of the target sound including a harmonic component that is perceptually more natural as audio can be generated, as compared with a configuration in which excessively large or excessively steep peaks in the harmonic spectral envelope Eh[t] are retained.

### Inharmonic Signal Generator 50

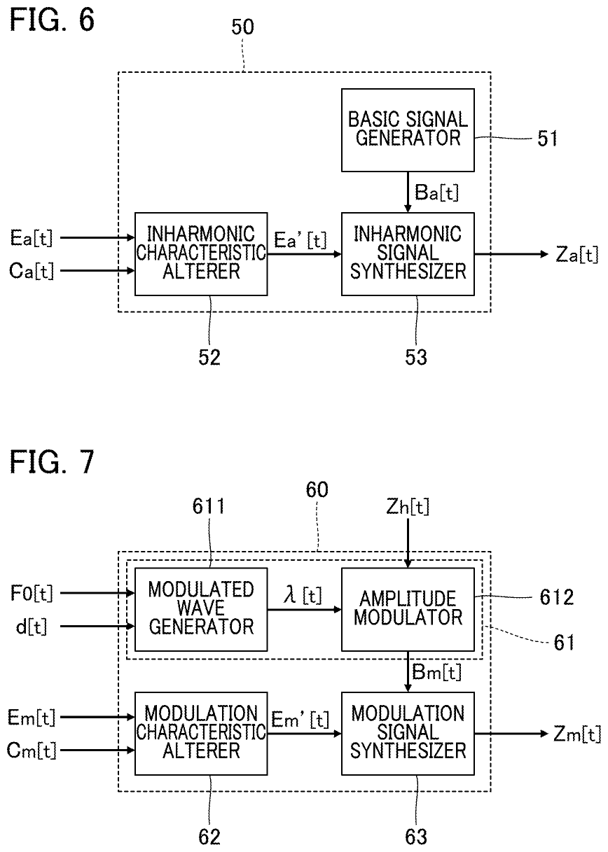

FIG. 6 is a block diagram illustrating a detailed configuration of the inharmonic signal generator 50. The inharmonic signal generator 50 includes a basic signal generator 51, an inharmonic characteristic alterer 52<opt>, and an inharmonic signal synthesizer 53.

The basic signal generator 51 generates a basic inharmonic signal Ba[t] for each unit period. FIG. 3 illustrates an intensity spectrum of the basic inharmonic signal Ba[t]. The basic inharmonic signal Ba[t] is a time-domain signal having a flat frequency characteristic. For example, the basic inharmonic signal Ba[t] is a noise signal representing white noise. Any known signal processing technique can be adopted for generation of the basic inharmonic signal Ba[t]. For example, the basic inharmonic signal Ba[t] is probabilistically generated by generation of a random number in accordance with a predetermined probability distribution.

A user can instruct an alteration relating to the inharmonic components of the target sound by operating the input device 14. The instruction data U described above includes an instruction on an alteration relating to the inharmonic components. The control data generator 21<opt> generates the inharmonic control data Ca[t]<opt> indicating an alteration to the inharmonic components in accordance with the instruction data U for each unit period. The inharmonic control data Ca[t]<opt> indicate, for example, an alteration to the inharmonic components for each frequency band on the frequency axis. For example, the direction of alteration (emphasis or suppression) of the inharmonic component and the degree of the alteration are indicated by the inharmonic control data Ca[t]<opt>. The inharmonic control data Ca[t]<opt> described above is supplied to the inharmonic signal generator 50. The inharmonic control data Ca[t]<opt> is optional and the inharmonic control data Ca[t]<opt> may or may not be generated.

The inharmonic characteristic alterer 52<opt> generates an inharmonic spectral envelope Ea′[t] by altering the shape of the inharmonic spectral envelope Ea[t]. Specifically, the inharmonic characteristic alterer 52<opt> receives the inharmonic control data Ca[t]<opt> from the control data generator 21<opt> and alters the inharmonic spectral envelope Ea[t] in accordance with the inharmonic control data Ca[t]<opt>. For example, the inharmonic characteristic alterer 52<opt> increases the component value of the inharmonic spectral envelope Ea[t] in a frequency band for which emphasis of the inharmonic component is indicated by the inharmonic control data Ca[t]<opt>, and reduces the component value of the inharmonic spectral envelope Ea[t] in a frequency band for which suppression of the inharmonic component is indicated by the inharmonic control data Ca[t]<opt>. As will be understood from the above explanation, the inharmonic control data Ca[t]<opt> indicates an alteration to the inharmonic spectral envelope Ea[t]. That is, the inharmonic characteristic alterer 52<opt> alters the inharmonic spectral envelope Ea[t] in accordance with an instruction from the user. When the inharmonic control data Ca[t]<opt> is not generated, the inharmonic characteristic alterer 52<opt> is omitted and the inharmonic spectral envelope Ea[t] is used as the inharmonic spectral envelope Ea′[t] without having its shape altered.

The inharmonic signal synthesizer 53 generates the inharmonic signal Za[t] in accordance with the inharmonic spectral envelope Ea′[t] and the basic inharmonic signal Ba[t]. FIG. 3 for sake of explanation illustrates an intensity spectrum of the inharmonic signal Za[t]. The inharmonic signal synthesizer 53 generates the inharmonic signal Za[t] by performing inharmonic filtering processing on the basic inharmonic signal Ba[t]. The inharmonic spectral envelope Ea′[t] is applied as response characteristics to the inharmonic filtering processing. As described above, according to the first embodiment, the inharmonic signal Za[t] can be easily generated by way of the time-domain processing in which the basic inharmonic signal Ba[t] is processed using the inharmonic spectral envelope Ea[t].

The configuration and processing of the inharmonic signal generator 50 to generate the inharmonic signal Za[t] are as described above. In the first embodiment, the inharmonic spectral envelope Ea[t] is altered in accordance with the inharmonic control data Ca[t]<opt>. Therefore, the inharmonic signal Za[t] having diverse audio properties can be generated, as compared with a configuration in which the inharmonic spectral envelope Ea[t] is not altered. That is, the audio properties of the inharmonic component of the target sound can be diversified. Furthermore, the inharmonic signal Za[t] is generated using the altered inharmonic spectral envelope Ea′[t] in accordance with the inharmonic control data Ca[t]<opt>, and the frequency characteristic Q[t] of the waveform signal W[t] generated from the inharmonic signal Za[t] is returned to the input side of the generative model M2. That is, an alteration to the inharmonic spectral envelope Ea[t] in accordance with the inharmonic control data Ca[t]<opt> is reflected in the generation of the frequency characteristic E[t] by the generative model M2. Accordingly, it is possible to generate the waveform signal W[t] of the target sound including an inharmonic component that is perceptually more natural as audio, as compared with the configuration in which the frequency characteristic E[t] is directly returned to the input side of the generative model M2. As will be understood from the above explanation, an alteration to the inharmonic spectral envelope Ea[t] in accordance with the inharmonic control data Ca[t]<opt> and the generation of the basic inharmonic signal Ba[t] are examples of fluctuation factors relating to the processing performed by the signal generator 32A to generate the waveform signal W[t] from the frequency characteristic E[t].

### Modulation Signal Generator 60<Opt>

FIG. 7 is a block diagram illustrating a detailed configuration of the modulation signal generator 60<opt>. The modulation signal generator 60<opt> includes a basic signal generator 61<opt>, a modulation characteristic alterer 62<opt>, and a modulation signal synthesizer 63<opt>. The modulation signal generator 60<opt> is optional and may be omitted from the sound processor 22 (or the signal generator 32A). When the modulation signal generator 60<opt> is omitted, the modulation signal Zm[t]<opt> is not generated.

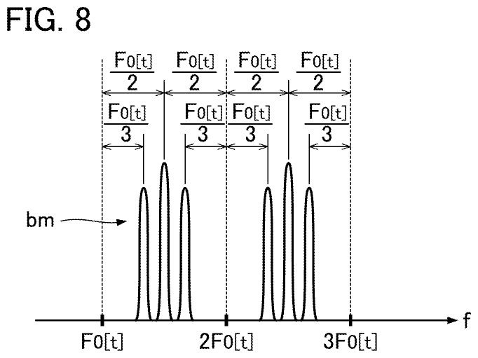

The basic signal generator 61<opt> generates a basic modulation signal Bm[t]<opt> for each unit period. FIGS. 3 and 8 for sake of explanation illustrate an intensity spectrum of the basic modulation signal Bm[t]<opt>. The basic modulation signal Bm[t]<opt> is a time-domain signal including a plurality of basic modulation components bm. Each of the plurality of basic modulation components bm is an audio component positioned in an interval between mutually adjacent sine waves h[t,n] and h[t,n+1] on the frequency axis. That is, there is a basic modulation component bm on either side of the harmonic frequency n·F0[t], i.e., on the high-frequency side and on the low-frequency side of each harmonic frequency n·F0[t]. Specifically, as illustrated in FIG. 8, a basic modulation component bm is at a frequency away from each harmonic frequency n·F0[t] to the high-frequency side and at a frequency away from each harmonic frequency n·F0[t] to the low-frequency side on the frequency axis, by a frequency F0[t]/k (k is an integer equal to or more than two) corresponding to 1/k of the fundamental frequency F0[t].

Specifically, the basic signal generator 61<opt> generates the basic modulation signal Bm[t]<opt> by amplitude-modulating the harmonic signal Zh[t], using a modulated wave λ[t]<opt>. As illustrated in FIG. 7, the basic signal generator 61<opt> includes a modulated wave generator 611<opt> and an amplitude modulator 612<opt>.

The modulated wave generator 611<opt> generates the modulated wave λ[t]<opt>. As expressed by the following formula (1), the modulated wave λ[t]<opt> is a time-domain signal including (K−1) audio components of the frequency F0[t]/k.

$$λ [ t ] = {\sum }_{k = 2}^{K} {d}_{k} cos ( 2 π \frac{F 0}{k} τ ) \qquad ( 1 )$$

Reference sign τ in the formula (1) denotes any of multiple time points in the unit period. As described above, the fundamental frequency F0[t] is calculated for each unit period. The fundamental frequency F0 of the formula (1) is calculated for each of the time points t in each unit period by interpolation of the fundamental frequency F0[t] in the unit period. That is, the fundamental frequency F0 of the formula (1) smoothly changes over the multiple time points t in the unit period.

The modulation degree d[t]<opt> described above includes (K−1) amplitude values d2 to dK. As will be understood from the formula (1), an audio component corresponding to the frequency F0[t]/k among the (K−1) audio components of the modulated wave λ[t]<opt> is set as the amplitude value dk. That is, the modulation degree d[t]<opt> is expressed as a variable for controlling the level of the modulation component. As will be understood from the above explanation, the modulated wave λ[t]<opt> has the waveform of a frequency (F0[t]/k) that has a predetermined relation to the fundamental frequency F0[t] of the harmonic signal Zh[t].

The amplitude modulator 612<opt> generates the basic modulation signal Bm[t]<opt> by subjecting the harmonic signal Zh[t] to amplitude modulation to which the modulated wave λ[t]<opt> is applied. Specifically, the amplitude modulator 612<opt> generates the basic modulation signal Bm[t]<opt> by multiplying the harmonic signal Zh[t] by the modulated wave

$$λ [ t ] 〈 opt 〉 ( Bm [ t ] = λ [ t ] \cdot Zh [ t ] ) .$$

A user can instruct an alteration of the modulation components of the target sound by operating the input device 14. The instruction data U described above includes an instruction on alteration of the modulation components. The control data generator 21<opt> generates the modulation control data Cm[t]<opt> indicating an alteration to the modulation components in accordance with the instruction data U for each unit period. The modulation control data Cm[t]<opt> indicates, for example, an alteration to the modulation component for each frequency band on the frequency axis. For example, the direction of alteration (emphasis/suppression) of the modulation component and the degree of the alteration are indicated by the modulation control data Cm[t]<opt>. The modulation control data Cm[t]<opt> described above is supplied to the modulation characteristic alterer 62<opt>. The modulation control data Cm[t]<opt> is optional and the modulation control data Cm[t]<opt> may or may not be generated.

The modulation characteristic alterer 62<opt> generates a modulation spectral envelope Em′[t]<opt> by altering the shape of the modulation spectral envelope Em[t]<opt>. Specifically, the modulation characteristic alterer 62<opt> receives the modulation control data Cm[t]<opt> from the control data generator 21<opt> and alters the modulation spectral envelope Em[t]<opt> in accordance with the modulation control data Cm[t]<opt>. For example, the modulation characteristic alterer 62<opt> increases the component value of the modulation spectral envelope Em[t]<opt> in a frequency band for which emphasis of the modulation component is indicated by the modulation control data Cm[t]<opt>, and decreases the component value of the modulation spectral envelope Em[t]<opt> in a frequency band for which suppression of the modulation component is indicated by the modulation control data Cm[t]<opt>. As will be understood from the above explanation, the modulation control data Cm[t]<opt> indicates an alteration of the modulation spectral envelope Em[t]<opt>. That is, the modulation characteristic alterer 62<opt> alters the modulation spectral envelope Em[t]<opt> in accordance with an instruction from the user. While the modulation signal generator 60<opt> is included in the sound processor 22, in a case in which the modulation control data Cm[t]<opt> is not generated, only the modulation characteristic alterer 62<opt> is omitted from the modulation signal generator 60<opt> and the modulation spectral envelope Em[t]<opt> is used as the modulation spectral envelope Em′[t]<opt> without having its shape altered.

The modulation signal synthesizer 63<opt> generates the modulation signal Zm[t]<opt> in accordance with the modulation spectral envelope Em′[t]<opt> and the basic modulation signal Bm[t]<opt>. FIG. 3 for sake of explanation illustrates an intensity spectrum of the modulation signal Zm[t]<opt>. The modulation signal synthesizer 63<opt> generates the modulation signal Zm[t]<opt> by processing the basic modulation signal Bm[t]<opt> so that the levels of the plurality of basic modulation components bm follow the modulation spectral envelope Em′[t]<opt>. That is, the level of each of the basic modulation components bm in the basic modulation signal Bm[t]<opt> is changed to the component value of the modulation spectral envelope Em′[t]<opt> corresponding to the frequency of the basic modulation component bm. Specifically, the modulation signal synthesizer 63<opt> generates the modulation signal Zm[t]<opt> by performing time-domain modulation filtering processing of the basic modulation signal Bm[t]<opt>. The modulation spectral envelope Em′[t]<opt> is applied as response characteristics to the modulation filtering processing. As illustrated above, according to the first embodiment, the modulation signal Zm[t]<opt> can be easily generated by the amplitude modulation to generate the basic modulation signal Bm[t]<opt> from the harmonic signal Zh[t] and the time-domain processing to process the basic modulation signal Bm[t]<opt> using the modulation spectral envelope Em[t]<opt>.

The configuration and processing of the modulation signal generator 60<opt> to generate the modulation signal Zm[t]<opt> are as described above. In the first embodiment, since the modulation spectral envelope Em[t]<opt> is altered in accordance with the modulation control data Cm[t]<opt>, the modulation signal Zm[t]<opt> having diverse audio properties can be generated as compared with a configuration in which the modulation spectral envelope Em[t]<opt> is not altered. That is, the audio property of the modulation component of the target sound can be diversified. Furthermore, the modulation signal Zm[t]<opt> is generated using the altered modulation spectral envelope Em′[t]<opt> in accordance with the modulation control data Cm[t]<opt>, and the frequency characteristic Q[t] of the waveform signal W[t] generated from the modulation signal Zm[t]<opt> is returned to the input side of the generative model M2. That is, an alteration to the modulation spectral envelope Em[t]<opt> in accordance with the modulation control data Cm[t]<opt> is reflected in the generation of the frequency characteristic E[t] by the generative model M2. Therefore, a waveform signal W[t] of the target sound including modulation components that are perceptually more natural as audio can be generated as compared with a configuration in which the frequency characteristic E[t] is directly returned to the input side of the generative model M2. As will be understood from the above explanation, an alteration to the modulation spectral envelope Em[t]<opt> in accordance with the modulation control data Cm[t]<opt> is one example of fluctuation factors relating to the processing performed by the signal generator 32A to generate the waveform signal W[t] from the frequency characteristic E[t].

### Waveform Generation Processing Sa

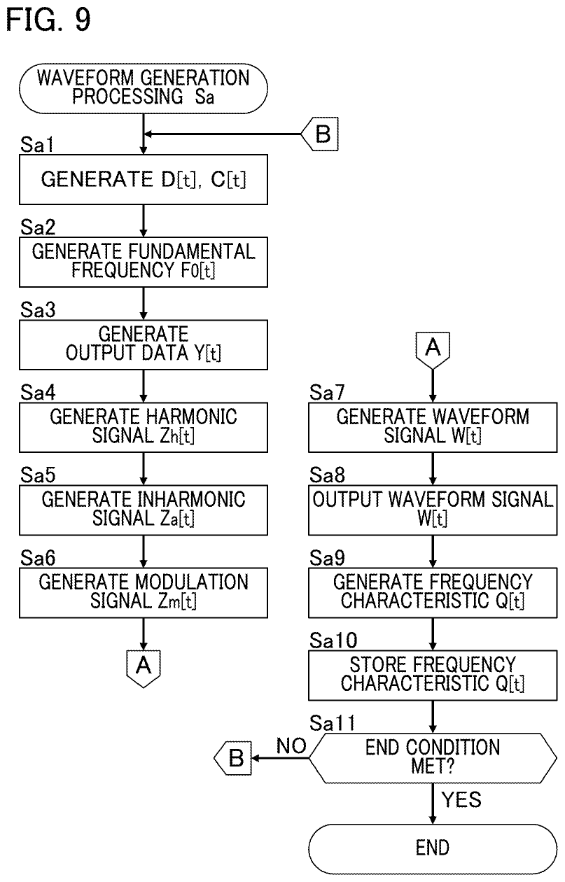

FIG. 9 is a flowchart illustrating a detailed procedure of processing (hereinafter, “waveform generation processing”) Sa performed by the control device 11, to generate a waveform signal W[t]. The waveform generation processing Sa is an example of a “sound processing method.” The waveform generation processing Sa is initiated, for example, in characteristic to an instruction from a user to the input device 14. A series of processes (Sa1 to Sa10) explained below is repeated for each unit period.

When the waveform generation processing Sa starts, the control data generator 21<opt> generates condition data D[t] and control data C[t]<opt> (Ch[t]<opt>, Ca[t]<opt>, and Cm[t]<opt>) in accordance with instruction data U (Sa1). As described above, the control data C[t]<opt> are optional and a part or all of the control data C[t]<opt> may or may not be generated. The first generator 31 generates the fundamental frequency F0[t] of a target sound from the condition data D[t] of the target sound (Sa2). Specifically, the first generator 31 generates a fundamental frequency F0[t] by processing the condition data D[t] using the trained generative model M1.

The first generator 31 generates output data Y[t] from input data X[t] (Sa3). Specifically, the first generator 31 generates the output data Y[t] by processing the input data X[t] using the trained generative model M2. As described above, the input data X[t] include the condition data D[t] of the target sound, the fundamental frequency F0[t] of the target sound, and the return data R[t]<opt>. The return data R[t]<opt> comprises a set of frequency characteristics Q[t−1] to Q[t-P] of P waveform signals W[t−1] to W[t-P] generated in unit periods prior to the current unit period.

The harmonic signal generator 40 generates a harmonic signal Zh[t] in accordance with the fundamental frequency F0[t] and a harmonic spectral envelope Eh[t] (and the harmonic control data Ch[t]<opt>) (Sa4). The inharmonic signal generator 50 generates an inharmonic signal Za[t] in accordance with an inharmonic spectral envelope Ea[t] (and the inharmonic control data Ca[t]<opt>) (Sa5). The modulation signal generator 60<opt> generates a modulation signal Zm[t]<opt> in accordance with the fundamental frequency F0[t], a modulation spectral envelope Em[t]<opt>, and the modulation control data Cm[t]<opt> (the modulation degree d[t]<opt>) (Sa6<opt>). The process at Step Sa6 may be omitted, whereby the modulation signal Zm[t]<opt> is not generated. The order of generation of the harmonic signal Zh[t] (Sa4), the generation of the inharmonic signal Za[t] (Sa5), and the generation of the modulation signal Zm[t]<opt> (Sa6<opt>) may be changed.

The signal mixer 70 generates a waveform signal W[t] of the target sound by mixing the harmonic signal Zh[t], the inharmonic signal Za[t], and the modulation signal Zm[t]<opt> (Sa7). In a case in which the modulation signal Zm[t]<opt> is not generated, the waveform signal W[t] is generated by mixing the harmonic signal Zh[t] and the inharmonic signal Za[t]. The signal mixer 70 outputs the waveform signal W[t] to the sound emitting device 13 (Sa8). Accordingly, the target sound is output from the sound emitting device 13.

The second generator 33 generates a frequency characteristic Q[t] from the waveform signal W[t] of the target sound (Sa9). The second generator 33 stores the frequency characteristic Q[t] of the waveform signal W[t] in the information retainer 121 (Sa10). The P frequency characteristics Q[t−1] to Q[t-P] stored in the information retainer 121 are used as the return data R[t]<opt> contained in the input data Z[t].

The control device 11 determines whether a predetermined end condition is met (Sa11). The end condition is, for example an end of the waveform generation processing Sa instructed by a user operation to the input device 14, or the above processing having been performed for the entire range of a piece of music represented by the music data S. When the end condition is not met (NO at Sa11), the control device 11 causes the processing to proceed to Step Sa1. That is, the generation (Sa1 to Sa7) and the output (Sa8) of the waveform signal W[t], and the generation (Sa9) and the storage (Sa10) of the frequency characteristic Q[t] are repeated for multiple unit periods. When the end condition is met (YES at Sa11), the control device 11 ends the waveform generation processing Sa.

### Machine Learning Processing Sb

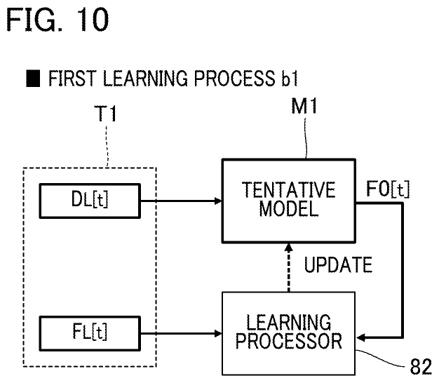

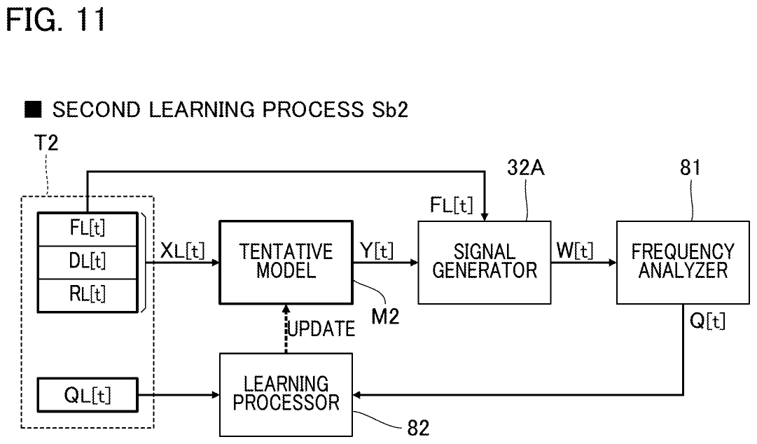

FIGS. 10 and 11 are block diagrams illustrating a functional configuration of the sound processing system 100 relating to machine learning processing Sb. The machine learning processing Sb is supervised machine learning for establishing the generative model M1 and the generative model M2. The machine learning processing Sb includes first learning processing Sb1 illustrated in FIG. 10 and second learning processing Sb2 illustrated in FIG. 11. The first learning processing Sb1 is machine learning for training the generative model M1. The second learning processing Sb2 is machine learning for establishing the generative model M2. That is, in the first embodiment, the generative model M1 and the generative model M2 are individually trained.

The storage device 12 stores a set of training data T1 for use in the first leaning processing Sb1 and a set of training data T2 for use in the second learning processing Sb2. Training data T1 of the set of training data T1 and training data T2 of the set of training data T2 are generated in advance using music data that represents a score of each of a piece of music (hereinafter, “piece of reference music”), and a reference signal that represents a reference sound corresponding to the piece of reference music. The reference sound is audio prepared in advance for the machine learning processing Sb. Specifically, the reference sound is a singing voice produced by a singer who sings the piece of reference music, or an instrumental sound produced by an instrumentalist who plays the piece of reference music on a musical instrument. Training data T1 and training data T2 are prepared for each of a plurality of unit periods obtained by dividing the reference signal on the time axis.

Training data T1 of the set of training data T1 includes condition data DL[t] representative of conditions of a reference sound, and a fundamental frequency FL[t]<opt> of the reference sound. The condition data DL[t] is substantially the same as the condition data D[t] described above and comprises a score feature amount generated from the music data of the piece of reference music. The fundamental frequency FL[t]<opt> of the reference sound is generated by analyzing the reference signal. The fundamental frequency FL[t]<opt> of training data T1 corresponds to a ground truth of a fundamental frequency F0[t], generated by the generative model M1 using the condition data DL[t] of the training data T1.

As illustrated in FIG. 11, training data T2 of the set of the training data T2 includes input data XL[t] and a frequency characteristic QL[t] of a reference signal. The input data XL[t] includes a fundamental frequency FL[t]<opt> and condition data DL [t] of the reference sound and return data RL[t] similarly to the input data X[t] described above. The fundamental frequency FL[t]<opt> and the condition data DL[t] of training data T1 corresponding to one unit period of the reference signal are the same as the fundamental frequency FL[t]<opt> and the condition data DL[t] of training data T2 corresponding to the subject unit period, respectively. The return data RL[t] corresponds to the return data R[t]<opt> described above and is data in accordance with a waveform signal W[t] generated prior to a target unit period, that is, data in accordance with the reference signal. Specifically, P frequency characteristics QL[t−1] to QL[t-P] of the reference signal are used as the return data RL[t].

The frequency characteristic QL[t] of training data T2 comprises an acoustic feature amount of the reference sound rendered in the frequency domain. For example, the frequency characteristic QL[t] is an acoustic feature amount, such as the MFSCs, the MFCCs, the amplitude spectrum, or the power spectrum of the reference sound. The frequency characteristic QL[t] of training data T2 corresponds to a ground truth relating to the frequency characteristic Q[t] of the waveform signal W[t], generated using the input data XL[t] of the training data T2. The frequency characteristic QL[t] includes harmonic components and inharmonic components of the reference sound, and may also optionally include modulation components.

In the machine learning processing Sb, the control device 11 functions also as a frequency analyzer 81 and a learning processor 82 in addition to the sound processor 22 described above. A detailed procedure of the machine learning processing Sb is explained below, focusing on the operations of the frequency analyzer 81 and the learning processor 82.

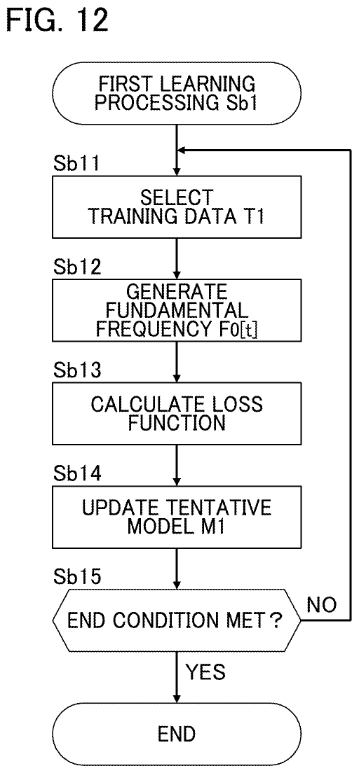

FIG. 12 is a flowchart illustrating a detailed procedure of the first learning processing Sb1. The first learning processing Sb1 is initiated, for example, in response to an instruction from a user to the input device 14.

When the first learning processing Sb1 is started, the learning processor 82 selects training data T1 (hereinafter, “selected training data T1”) from the set of training data T1 (Sb11). As illustrated in FIG. 10, the learning processor 82 generates a fundamental frequency F0[t] by processing condition data DL[t] of the selected training data T1 with a tentative generative model M1 (hereinafter, “tentative model M1”) (Sb12). Either an untrained model or a trained model is used as an initial model of the tentative generative model M1.

The learning processor 82 calculates a loss function representing an error between the fundamental frequency F0[t] generated by the tentative model M1 and the fundamental frequency FL[t]<opt> of the reference sound of the selected training data T1 (Sb13). The learning processor 82 updates a plurality of variables of the tentative model M1 to reduce (ideally minimize) the loss function (Sb14). For example, an error backpropagation method is used to update variables depending on the loss function.

The learning processor 82 determines whether a predetermined end condition is met each time no unselected training data T1 remains (Sb15). The end condition is, for example, when the loss function falls below a predetermined threshold, or an amount of change of the loss function falls below a predetermined threshold. When unselected training data T1 remains or the end condition is not met (NO at Sb15), the learning processor 82 performs the following processing. When unselected training data T1 remains, the learning processor 82 selects the remaining training data T1 as new training data T1. When no unselected training data T1 remains, the learning processor 82 reverts the set of training data T1 to unselected states and selects training data T1 from the reverted set of training data T1 as new training data T1 (Sb11). That is, the processes (Sb11 to Sb14) for updating the plurality of variables of the tentative model M1 are repeated until the end condition is met (YES at Sb15). When the end condition is met (YES at Sb15), the learning processor 82 ends the first learning processing Sb1. The tentative model M1 obtained at the time when the end condition is met is established as the generative model M1. Specifically, the plurality of variables defining the generative model M1 is established as the values when the end condition is met.

As will be understood from the above explanation, the generative model M1 learns a relation between the condition data D[t] and the fundamental frequency F0[t]. That is, the generative model M1 learns a potential relation between the condition data DL[t] and the fundamental frequency FL[t]<opt> in the set of training data T1. Accordingly, the generative model M1 for which the first learning processing Sb1 has been performed generates a fundamental frequency F0[t] that is statistically adequate for unknown condition data D[t].

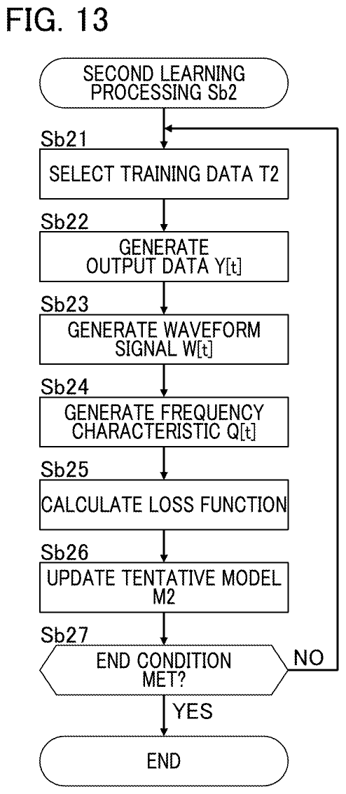

FIG. 13 is a flowchart illustrating a detailed procedure of the second learning processing Sb2. The second learning processing Sb2 is initiated, for example, in response to an instruction from a user to the input device 14. The order of the first learning processing Sb1 and the second learning processing Sb2 may be reversibly selected. That is, the second learning processing Sb2 may be performed after the first learning processing Sb1, or the first learning processing Sb1 may be performed after the second learning processing Sb2.

When the second learning processing Sb2 starts, the learning processor 82 selects training data T2 (hereinafter, “selected training data T2”) from the set of training data T2 (Sb21). As illustrated in FIG. 11, the learning processor 82 generates output data Y[t] by processing input data XL[t] of the selected training data T2 with a tentative generative model M2 (hereinafter, “tentative model M2”) (Sb22). The signal generator 32A generates a waveform signal W[t] from the output data Y[t] generated by the tentative model M2 and a fundamental frequency FL[t]<opt> of the selected training data T2 (Sb23). Either an untrained model or a trained model is used as an initial model of the tentative generative model M2.

In the second learning processing Sb2, control data C[t]<opt> (Ch[t]<opt>, Ca[t]<opt>, and Cm[t]<opt>) used for generating the waveform signal W[t] are fixed to a predetermined value. Specifically, the harmonic control data Ch[t]<opt> is set to have a value that indicates no alteration to the harmonic spectral envelope Eh[t]. Therefore, the harmonic characteristic alterer 42<opt> sets the harmonic spectral envelope Eh[t] in the output data Y[t] as the harmonic spectral envelope Eh′[t]. Similarly, the inharmonic control data Ca[t]<opt> is set to have a value that indicates no alteration to the inharmonic spectral envelope Ea[t]. Therefore, the inharmonic characteristic alterer 52<opt> sets the inharmonic spectral envelope Ea[t] in the output data Y[t] as the inharmonic spectral envelope Ea′[t]. The modulation control data Cm[t]<opt> is set to have a value that indicates no alteration to the modulation spectral envelope Em[t]<opt>. Therefore, the modulation characteristic alterer 62<opt> sets the modulation spectral envelope Em[t]<opt> in the output data Y[t] as the modulation spectral envelope Em′[t]<opt>. The control data C[t]<opt> provides no control and is essentially the same as having been omitted.

Similarly to the second generator 33 described above, the frequency analyzer 81 in FIG. 11 generates a frequency characteristic Q[t] from the waveform signal W[t] (Sb24). For example, a frequency analysis method such as short-time Fourier transform is used to generate the frequency characteristic Q[t].

The learning processor 82 calculates a loss function representative of an error between the frequency characteristic Q[t] generated by the frequency analyzer 81 and the frequency characteristic QL[t] of the selected training data T2 (Sb25). The learning processor 82 updates a plurality of variables of the tentative model M2 to reduce (ideally minimize) the loss function (Sb26). For example, an error backpropagation method is used to update the variables depending on the loss function.

The learning processor 82 determines whether a predetermined end condition is met each time no unselected training data T2 (Sb27) remains. The end condition is, for example, when the loss function falls below a predetermined threshold, or the amount of change of the loss function falls below a predetermined threshold. When unselected training data T2 remains or the end condition is not met (NO at Sb27), the learning processor 82 performs the following processing. When unselected training data T2 remains, the learning processor 82 selects the remaining training data T2 as new training data T2. When no unselected training data T2 remains, the learning processor 82 reverts the set of training data T2 to unselected states and selects training data T2 of the reverted set of training data T2 as new training data T2 (Sb21). That is, the processes (Sb21 to Sb26) to update the plurality of variables of the tentative model M2 are repeated until the end condition is met (YES at Sb27). When the end condition is met (YES at Sb27), the learning processor 82 ends the second learning processing Sb2. The tentative model M2 obtained at the time when the end condition is met is established as the generative model M2. Specifically, the plurality of variables defining the generative model M2 is established as the values when the end condition is met.

As will be understood from the above explanation, the generative model M2 learns a relation between the input data X[t] and the output data Y[t]. That is, the generative model M2 learns a potential relation between the input data XL[t] and the output data Y[t] corresponding to the frequency characteristic QL[t] in the set of the training data T2. Accordingly, the generative model M2 for which the second learning processing Sb2 has been performed generates output data Y[t] that is statistically adequate for unknown input data X[t].

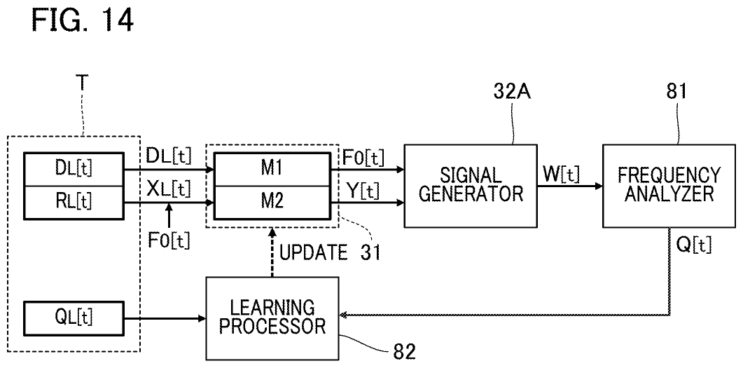

In the above explanations, an approach is described in which the generative model M1 and the generative model M2 are individually trained. However, the generative model M1 and the generative model M2 may be collectively trained. For example, FIG. 14 is a block diagram illustrating a functional configuration of a mode in which the generative model M1 and the generative model M2 are collectively trained. Training data T of the set of training data T includes condition data DL[t] of a reference sound, return data RL[t], and a frequency characteristic QL[t] of the reference sound, and may also include a fundamental frequency FL[t]<opt> of the reference sound.

The learning processor 82 generates a fundamental frequency F0[t] by processing the condition data DL[t] of the training data T with a tentative model M1. The learning processor 82 generates output data Y[t] by processing the input data XL[t] with a tentative model M2. The input data XL[t] includes condition data DL[t] and return data RL[t] of the training data T and the fundamental frequency F0[t] generated by the tentative model M1. The signal generator 32A generates a waveform signal W[t] using the fundamental frequency F0[t] and the output data Y[t]. The frequency analyzer 81 generates a frequency characteristic Q[t] based on the waveform signal W[t]. The learning processor 82 updates the variables of the tentative model M1 and the plurality of variables of the tentative model M2 to reduce errors between the frequency characteristic Q[t] generated by the frequency analyzer 81 and the frequency characteristic QL[t] of the training data T. When training data T includes the fundamental frequency FL[t]<opt> of the reference sound, the learning processor 82 updates the plurality of variables of the tentative model M1 and the plurality of variables of the tentative model M2 to reduce errors between the fundamental frequency F0[t] generated by the frequency analyzer 81 and the fundamental frequency FL[t]<opt> of the training data T, and errors between the frequency characteristic Q[t] generated by the frequency analyzer 81 and the frequency characteristic QL[t] of the training data T.

According to the machine learning processing Sb described with reference to FIG. 14, the generative model M1 and the generative model M2 can be collectively trained. In contrast, according to the approach described earlier for individually training the generative model M1 and the generative model M2, less time is required for the machine learning processing Sb, and the generative model M1 and the generative model M2 can be trained more efficiently.

### B: Second Embodiment

A second embodiment will now be explained. In the modes exemplified below, elements having substantially the same function as those described in the first embodiment are denoted by reference signs used in the explanations of the first embodiment and detailed explanations thereof are omitted, as appropriate.

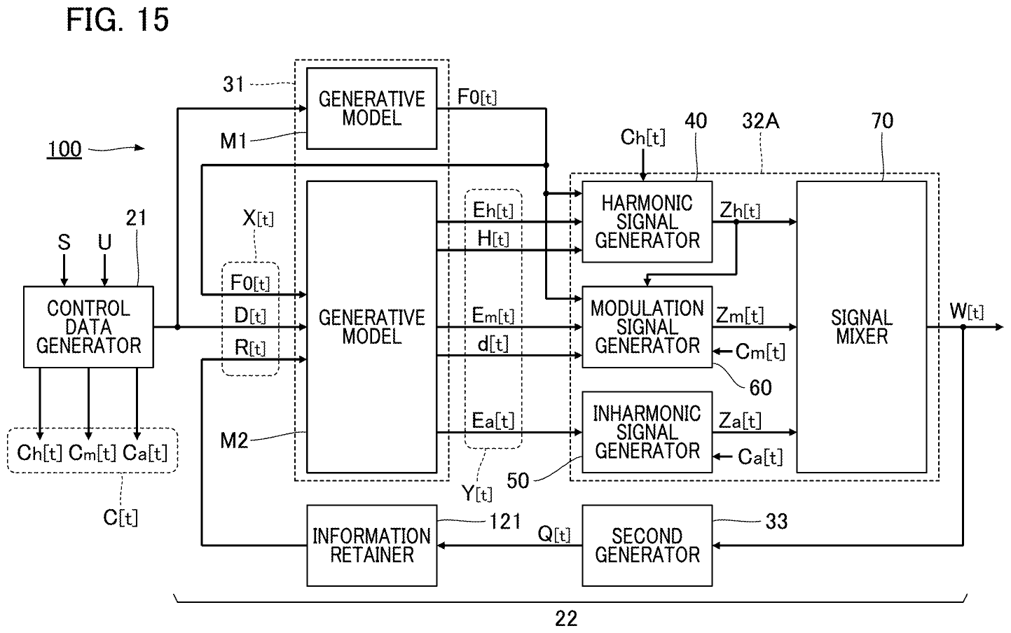

FIG. 15 is a block diagram illustrating a functional configuration of a sound processing system 100 according to the second embodiment. Output data Y[t] in the second embodiment includes phase information H[t] in addition to elements (only E[t], or E[t] and d[t]<opt>) substantially the same as those in the first embodiment. That is, the generative model M2 outputs the output data Y[t] including the phase information H[t] in accordance with the input data X[t]. The phase information H[t] relates to the phase of the harmonic components of a target sound. Specifically, the phase information H[t] of the target sound represents a contour or a shape (hereinafter, “phase spectral envelope”) of a phase spectrum of harmonic components of the target sound. The phase spectral envelope is a series of phase values at frequencies on the frequency axis.

Similarly to the generative model M2 in the first embodiment, this generative model M2 is trained by the machine learning processing Sb explained with reference to FIGS. 11 and 13. By this training, the generative model M2 learns a potential relation between (i) the input data XL[t] in the set of training data T2 and (ii) the output data Y[t] corresponding to the frequency characteristic QL[t] and including the phase information H[t].

A harmonic signal generator 40 generates a harmonic signal Zh[t] in accordance with a fundamental frequency F0[t], a harmonic spectral envelope Eh[t], and the phase information H[t] of the target sound, and harmonic control data Ch[t]<opt>. In the second embodiment, the frequency characteristic E[t] (Eh[t], Ea[t], and Em[t]<opt>) and the phase information H[t] correspond to the “first acoustic feature amount.” That is, the “first acoustic feature amount” includes the frequency characteristic E[t] and the phase information H[t]. The harmonic control data Ch[t]<opt> may or may not be used for generating the harmonic signal Zh[t]. The frequency characteristic E[t] may or may not contain the modulation spectral envelope Em[t]<opt>.

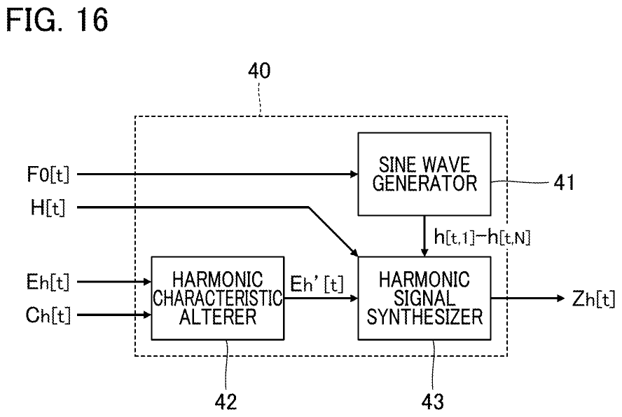

FIG. 16 is a block diagram of the harmonic signal generator 40. The harmonic signal synthesizer 43 of the second embodiment generates a harmonic signal Zh[t] in accordance with a harmonic spectral envelope Eh′[t], the phase information H[t], and N sine waves h[t,1] to h[t,N]. The harmonic signal synthesizer 43 adjusts the phase of each sine wave h[t,n] in accordance with the phase spectral envelope represented by the phase information H[t]. Specifically, the harmonic signal synthesizer 43 processes each sine wave h[t,n] so that phases of the N sine waves h[t,1] to h[t,N] follow the phase spectral envelope of the phase information H[t]. That is, the phase of each sine wave h[t,n] is changed to a phase value corresponding to the harmonic frequency n·F0[t] in the phase spectral envelope.

Assumed here is a time series (hereinafter, “fundamental pulse sequence”) of a plurality of pulses arranged on the time axis at intervals of a fundamental period that is the inverse of the fundamental frequency F0[t]. The glottis of the vocal cords opens and closes at the fundamental frequency F0[t]. Each pulse of the fundamental pulse sequence corresponds to a time point at which the glottis of the vocal cords closes. The harmonic signal synthesizer 43 adjusts the phase of each sine wave h[t,n] in a unit period to have a corresponding phase value of the phase spectral envelope represented by the phase information H[t] at a time point of a pulse closest to a reference point in the unit period, among the plurality of pulses of the fundamental pulse sequence. The reference point is a specific time point in the unit period. For example, the midpoint of the unit period is the reference point.

The second embodiment is substantially the same as the first embodiment in that, after the phases are adjusted, the levels of the respective sine waves h[t,n] are changed in accordance with the harmonic spectral envelope Eh′[t] and a harmonic signal Zh[t] is generated by synthesis of the changed N sine waves h[t,1] to h[t,N]. That is, the generation of the harmonic signal Zh[t] by the harmonic signal synthesizer 43 includes processing to adjust the levels of the N sine waves h[t,1] to h[t, N] in accordance with the harmonic spectral envelope Eh′[t] and processing to adjust the phases of the N sine waves h[t,1] to h[t,N] in accordance with the phase information H[t]. The adjustment of the phases using the phase information H[t] can be performed either before or after the adjustment of the levels using the harmonic spectral envelope Eh′[t].

The configuration and operation of the second embodiment except for the use of the phase information H[t] for the generation of the harmonic signal Zh[t] are substantially the same as those of the first embodiment. Accordingly, the second embodiment realizes substantially the same effects as those of the first embodiment. Since the phase information H[t] is used for generating the harmonic signal Zh[t] in the second embodiment, a higher quality waveform signal W[t] of the target sound can be generated as compared with the first embodiment in which the phase information H[t] is not used. The second embodiment can be modified in the manners described below.

(1) The method for reflecting the phase information H[t] in the harmonic signal Zh[t] is not limited to the above example. For example, the harmonic signal Zh[t] in accordance with the phase information H[t] may be generated by one of the following first to third modes.

### First Mode

In substantially the same manner as in the first embodiment, the harmonic signal generator 40 generates an intermediate signal of a harmonic component by changing the levels of the N sine waves h[t,1] to h[t,N] in accordance with the harmonic spectral envelope Eh′[t] and synthesizing the changed N sine waves h[t,1] to h[t,N]. The harmonic signal generator 40 generates the harmonic signal Zh[t] by processing the intermediate signal with a filter. The phase characteristic of the filter is set to the phase spectral envelope represented by the phase information H[t]. Therefore, in substantially the same manner as in the second embodiment, the harmonic signal Zh[t] is generated in accordance with the harmonic spectral envelope Eh′[t] and the phase information H[t].

### Second Mode

In substantially the same manner as in the second embodiment, the harmonic signal generator 40 generates an intermediate signal of the harmonic signal by changing the phases of the N sine waves h[t,1] to h[t,N] in accordance with the phase information H[t] and synthesizing the changed N sine waves h[t,1] to h[t,N]. The harmonic signal generator 40 generates the harmonic signal Zh[t] by processing the intermediate signal with a filter. The amplitude response of the filter is set to the harmonic spectral envelope Eh′[t]. Therefore, in substantially the same manner as in the second embodiment, the harmonic signal Zh[t] is generated in accordance with the harmonic spectral envelope Eh′[t] and the phase information H[t].

### Third Mode

The harmonic signal generator 40 generates the harmonic signal Zh[t] by processing the fundamental pulse sequence with a filter. The sine wave generator 41 in FIG. 16 is replaced by a fundamental pulse generator configured to generate a fundamental pulse instead of a sine wave. In the harmonic signal synthesizer 43, the amplitude response of the filter is set to the harmonic spectral envelope Eh′[t] and the phase response of the filter is set to the phase spectral envelope represented by the phase information H[t]. Therefore, in substantially the same manner as the first and second modes, the harmonic signal Zh[t] is generated in accordance with the harmonic spectral envelope Eh′[t] and the phase information H[t].

(2) In the second embodiment, the phase spectral envelope represented by the phase information H[t] is a sequence of phase values corresponding to frequencies on the frequency axis. However, the phase spectral envelope represented by the phase information H[t] may be, for example, a sequence of N phase values corresponding to different harmonic frequencies n·F0[t] on the frequency axis. Thus, phase values corresponding to frequencies other than the harmonic frequencies n·F0[t] may be omitted.

(3) The phase spectral envelope of a harmonic component is likely to correlate with the harmonic spectral envelope. The correlation between a phase spectral envelope and a harmonic spectral envelope is also described in, for example, “Voice Processing and Synthesis by Performance Sampling and Spectral Models,” PhD Thesis, Universitat Pompeu Fabra, 2008.

Taking into account the correlation mentioned above, the phase spectral envelope is expressed as a function of the harmonic spectral envelope. Specifically, a function to generate the phase spectral envelope from the harmonic spectral envelope Eh[t] or the harmonic spectral envelope Eh′[t] is assumed. The phase information H[t] may represent one or more parameters defining the function referred to above. The harmonic signal generator 40 generates the phase spectral envelope by applying the harmonic spectral envelope Eh[t] or the harmonic spectral envelope Eh′[t] to the function defined by the parameters represented by the phase information H[t]. Any of the methods described in the second embodiment or the following modification can be used for generating the harmonic signal Zh[t] using the phase spectral envelope. As will be understood from the above explanations, the phase information H[t] is not limited to the information directly representing the phase spectral envelope. The phase information H[t] representing the parameters of the function may be referred to as information representing the phase spectral envelope or as information for generating the phase spectral envelope.

### C: Third Embodiment

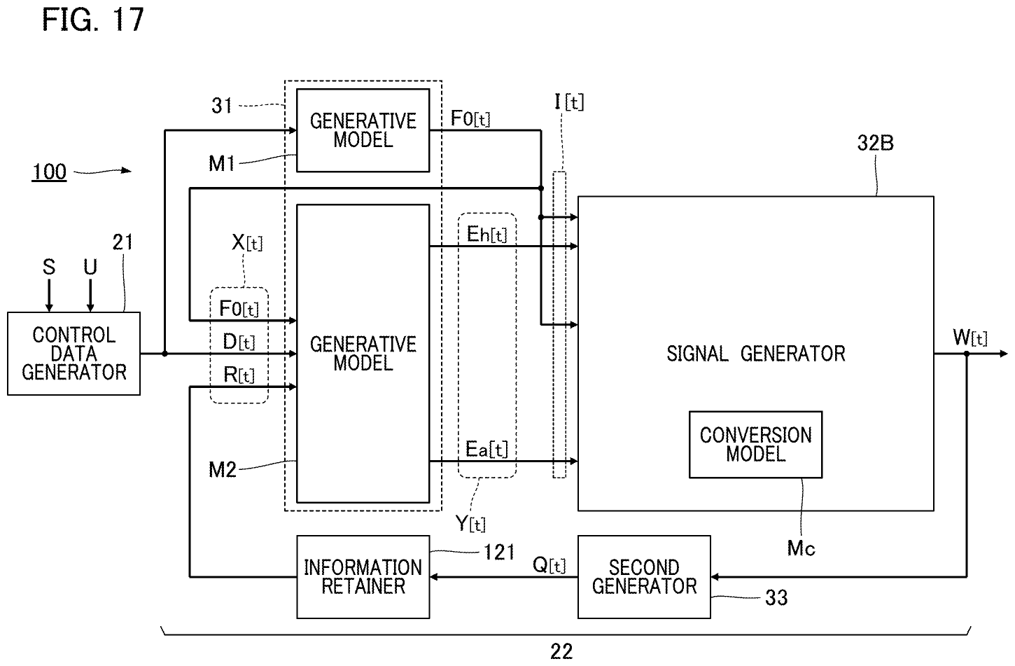

FIG. 17 is a block diagram illustrating a functional configuration of the sound processing system 100 according to a third embodiment. In the sound processing system 100 of the third embodiment, the signal generator 32A of the first embodiment is replaced by a signal generator 32B. The configurations and operations of elements (a control data generator 21<opt>, a first generator 31, and a second generator 33) other than the signal generator 32B are substantially the same as those in the first embodiment.

The signal generator 32B generates a waveform signal W[t] in accordance with a fundamental frequency F0[t] of the target sound and output data Y[t] for each time unit similarly to the signal generator 32A. Input data I[t] in FIG. 17 includes the fundamental frequency F0[t] and the output data Y[t] and does not include the control data C[t]<opt> as an option. The output data Y[t] does not include the modulation spectral envelope Em[t]<opt> or the modulation degree d[t]<opt> as options.

A trained conversion model Mc is used for generating the waveform signal W[t] by the signal generator 32B. The conversion model Mc is a learned model (a known neural vocoder) that learns a relation between the input data I[t] and the waveform signal W[t]. The signal generator 32B generates the waveform signal W[t] by processing the input data I[t] with the conversion model Mc. Focusing on the frequency characteristic E[t] in the input data I[t], the signal generator 32B generates the waveform signal W[t] by processing the frequency characteristic E[t] with the conversion model Mc.

Any known neural vocoder to which the input data I[t] can be input may be used as the conversion model Mc. The input data I[t] to be input to the conversion model Mc is not limited to the above example. When a neural vocoder with a different form of input data I[t] is used as the conversion model Mc, a trained model trained to generate output data Y[t] of the same form as that of the input data I[t] as the generative model M2 can be used.

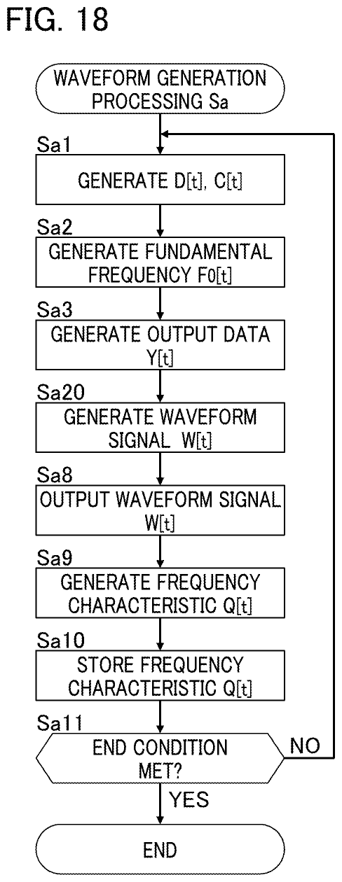

FIG. 18 is a flowchart illustrating a procedure of the waveform generation processing Sa of the third embodiment. In the waveform generation processing Sa of the third embodiment, Steps Sa4 to Sa7 in the waveform generation processing Sa of the first embodiment are replaced by Step Sa20 in FIG. 18. At Step Sa20, the signal generator 32B generates a waveform signal W[t] by processing input data I[t] with the conversion model Mc. Processes other than Step Sa20 are substantially the same as those in the first embodiment. Also in the third embodiment, substantially the same effects as those in the first embodiment are realized.

### D: Modifications

Specific modifications of the embodiments described above are exemplified below. Two or more modifications optionally selected from the following exemplifications may be appropriately combined with each other in so far as no contradiction arises.

(1) In the embodiments described above, the generative model M1 and the generative model M2 are described as different models. However, the generative model M1 and the generative model M2 may constitute one model (hereinafter, “integrated model”). The integrated model is a statistical estimation model that learns a relation between (i) the input data X[t], and (ii) the fundamental frequency F0[t] and the output data Y[t]. The first generator 31 sequentially generates the fundamental frequency F0[t] of the target sound and the output data Y[t] by sequentially processing the input data X[t] with the integrated model. The integrated model described above is also included in the concept of “generative model” in the present disclosure.

(2) In the embodiments described above, the harmonic control data Ch[t]<opt> indicates in binary form whether to make an alteration to the harmonic component. However, an indication represented by the harmonic control data Ch[t]<opt> is not limited to the above example. For example, the harmonic control data Ch[t]<opt> may directly indicate content of an alteration to the harmonic component. For example, the harmonic control data Ch[t]<opt> indicates an alteration to the harmonic component for each frequency band on the frequency axis. For example, the direction of the alteration (emphasis/suppression) of the harmonic component and the degree of the alteration are indicated by the harmonic control data Ch[t]<opt>. The harmonic characteristic alterer 42<opt> increases the component value of the harmonic spectral envelope Eh[t] of a frequency band for which emphasis of the harmonic component is indicated, and reduces the component value of the harmonic spectral envelope Eh[t] of a frequency band for which suppression of the harmonic component is indicated. The adjustment value α for target peaks described above may be indicated by the harmonic control data Ch[t]<opt>. The harmonic characteristic alterer 42<opt> suppresses target peaks in accordance with the adjustment value α indicated by the harmonic control data Ch[t]<opt>. That is, the degree of suppression of each target peak of the harmonic spectral envelope Eh[t] is controlled in accordance with an instruction from a user.

(3) In the embodiments described above, the inharmonic control data Ca[t]<opt> indicates an alteration to the inharmonic component for each frequency band on the frequency axis. However, an indication represented by the inharmonic control data Ca[t]<opt> is not limited to the above example. For example, the inharmonic control data Ca[t]<opt> indicates in binary form whether to make an alteration to the inharmonic component. In a case in which alteration of the inharmonic component is indicated by the inharmonic control data Ca[t]<opt>, the inharmonic characteristic alterer 52<opt> changes the component value of the inharmonic spectral envelope Ea[t] in accordance with a predetermined rule. In a case in which non-alteration of the inharmonic component is instructed by the inharmonic control data Ca[t]<opt>, the inharmonic characteristic alterer 52<opt> sets the inharmonic spectral envelope Ea[t] as the inharmonic spectral envelop Ea′[t].

(4) In the embodiments described above, the modulation control data Cm[t]<opt> indicates an alteration to the modulation component for each frequency band on the frequency axis. However, an indication represented by the modulation control data Cm[t]<opt> is not limited to the above example. For example, the modulation control data Cm[t]<opt> indicates in binary form whether to make an alteration to the modulation component. In a case in which alteration of the modulation component is indicated by the modulation control data Cm[t]<opt>, the modulation characteristic alterer 62<opt> changes the component value of the modulation spectral envelope Em[t]<opt> in accordance with a predetermined rule. Further, in a case in which non-alteration of the modulation component is indicated by the modulation control data Cm[t]<opt>, the modulation characteristic alterer 62<opt> sets the modulation spectral envelope Em[t]<opt> as the modulation spectral envelop Em′[t]<opt>.

(5) In the embodiments described above, an approach by which the frequency characteristics E[t] (Eh[t], Ea[t], and Em[t]<opt>) are changed in accordance with the control data C[t]<opt> (Ch[t]<opt>, Ca[t]<opt>, and Cm[t]<opt>) has been described. However, an alteration to the frequency characteristic E[t] is optional and may be omitted. That is, the harmonic characteristic alterer 42<opt>, the inharmonic characteristic alterer 52<opt>, and the modulation characteristic alterer 62<opt> in the embodiments described above may be omitted. In the embodiments described above, the frequency characteristic E[t] is changed in accordance with an instruction (the instruction data U) provided from a user. However, a manner of applying an alteration to the frequency characteristic E[t] is not limited to an instruction provided from a user. The control data C[t]<opt> may be generated in accordance with, for example, instruction data U received from an external device or instruction data U generated by other functions of the sound processing system 100.

(6) In the embodiments described above, the sound processing system 100 performs both the waveform generation processing Sa and the machine learning processing Sb. However, in a case in which the learned generative models M1 and M2 are available, the machine learning processing Sb may be omitted. A machine learning system that performs only the machine learning processing Sb can also be realized. The machine learning system establishes the generative models M1 and M2 (or the integrated model described above) by performing the machine learning processing Sb described in the first embodiment. The generative models M1 and M2 established by the machine learning system are transferred to the sound processing system 100 and are used for the waveform generation processing Sa.

(7) In the embodiments described above, musical sounds such as singing voice sounds produced by singers or instrumental sounds output from musical instruments are given as examples of target sounds. However, musical sounds are not essential elements for the target sound. For example, the modes described above can similarly be applied to a case in which sounds of talking that do not include musical elements are generated as the target sound.

(8) In the embodiments described above, the generative model M1 and the generative model M2 are not limited to a deep neural network. For example, any form or type of statistical model such as a Hidden Markov Model (HMM) or a Support Vector Machine (SVM) may be used as one or both of the generative model M1 and the generative model M2. Similarly, any form or type of model can be used for the conversion model Mc of the third embodiment.

(9) The sound processing system 100 may be realized by, for example, a server apparatus configured to communicate with an information apparatus such as a smartphone or a tablet. For example, the sound processing system 100 receives music data S and instruction data U from the information apparatus and generates a waveform signal W[t] by the waveform generation processing Sa described above. The sound processing system 100 transmits the waveform signal W[t] (the audio signal A) generated by the waveform generation processing Sa to the information apparatus. The music data S may be retained in the sound processing system 100.

(10) The generative model M2 in the embodiments described above generates a modulation spectral envelope Em[t]<opt> in addition to a harmonic spectral envelope Eh[t] and an inharmonic spectral envelope Ea[t]. To establish the generative model M2 configured to generate a frequency characteristic E[t] including a modulation spectral envelope Em[t]<opt>, a method (hereinafter, “comparative method”) of performing the machine learning processing Sb using a set of training data T including reference data L[t] and a frequency characteristic E[t] is also assumed. The frequency characteristic E[t] of training data T of the set of training data T corresponds to a ground truth of the reference data L[t] and includes a harmonic spectral envelope Eh[t], an inharmonic spectral envelope Ea[t], and a modulation spectral envelope Em[t]<opt>. Therefore, in order to realize such comparative method, it is necessary to prepare a large number of modulation spectral envelopes Em[t]<opt>. However, practically it is not easy to extract only modulation components from the reference sounds with high accuracy.

In the embodiments described above, in contrast to the comparative method, a frequency characteristic QL[t] of a reference sound including harmonic components, inharmonic components, and modulation components is contained as a ground truth in the training data T. Consequently, it is possible to establish a generative model M2 that can generate a frequency characteristic E[t] including a modulation spectral envelope Em[t]<opt> without extracting the modulation components of the reference sound. That is, the embodiments described above have an advantage in that it is easier to prepare a set of training data T to be used for the machine learning processing Sb of the generative model M2 than in the comparative method.

From the standpoint described above, machine learning methods (generative model establishing methods) described below are also specified by the present disclosure. A generative model establishing method according to one aspect is:
a method (a generative model establishing method) realized by a computer system for establishing a generative model M2 configured to generate a frequency characteristic E[t] including a harmonic spectral envelope Eh[t] relating to a harmonic component of a target sound and a modulation spectral envelope Em[t]<opt> relating to a modulation component of the target sound, from input data X[t] including condition data D[t] that represent conditions of the target sound, by machine learning processing Sb using a set of training data T, in which
training data T of the set of training data T includes
input data X[t] including condition data D[t] that represents conditions of a reference sound, and
a frequency characteristic QL[t] including a harmonic component and a modulation component of the reference sound,
a first generator 31 generates the frequency characteristic E[t] by processing the input data X[t] with a tentative generative model M2,
a signal generator 32 (32A and 32B) generates a waveform signal W[t] based on the frequency characteristic E[t],
a frequency analyzer 81 generates a frequency characteristic Q[t] from the waveform signal W[t], and
a learning processor 82 updates a plurality of variables of the tentative generative model M2 to reduce a difference between the frequency characteristic Q[t] generated based on the waveform signal W[t] and the frequency characteristic QL[t] contained in the training data T.

According to the above method, as described above, it is possible to establish the generative model M2, which can generate the frequency characteristic E[t] including the modulation spectral envelope Em[t]<opt>, without extracting modulation components of the reference sound. Therefore, the set of training data T to be used for the machine learning processing Sb of the generative model M2 can be easily prepared.

In the generative model establishing method described above, use of modulation components may be omitted. That is, a generative model establishing method according to one aspect is:
a method (a generative model establishing method) realized by a computer system for establishing a generative model M2 configured to generate a frequency characteristic E[t] including a harmonic spectral envelope Eh[t] relating to a harmonic component of a target sound, from input data X[t] including condition data D[t] that represents conditions of the target sound, by machine learning processing Sb using a set of training data T, in which
training data of the set of the training data T includes input data X[t] including condition data D[t] that represents conditions of a reference sound, and
a frequency characteristic QL[t] including a harmonic component of the reference sound,
a first generator 31 generates the frequency characteristic E[t] by processing the input data X[t] with a tentative generative model M2,
a signal generator 32 (32A and 32B) generates a waveform signal W[t] based on the frequency characteristic E[t],
a frequency analyzer 81 generates a frequency characteristic Q[t] based on the waveform signal W[t], and
a learning processor 82 updates a plurality of variables of the tentative generative model M2 to reduce a difference between the frequency characteristic Q[t] generated based on the waveform signal W[t] and the frequency characteristic QL[t] included in the training data T.

(11) As described above, the functions of the sound processing system 100 are realized by cooperation of one or more processors constituting the control device 11 and the programs stored in the storage device 12. The programs may be stored in a recording medium from which a computer can read the programs, or may be installed in the computer. The recording medium is, for example, a non-transitory recording medium. While an optical recording medium (an optical disk) such as a compact disk read-only memory (CD-ROM) is a preferred example, any known form of recording media such as a semiconductor recording medium or a magnetic recording medium are also included. A non-transitory recording medium includes any recording media other than a transitory propagating signal, and volatile recording media are not excluded therefrom. In a configuration in which a distributing device distributes programs through a communication network, a recording medium that stores therein programs in the distributing device corresponds to the non-transitory recording medium described above.

### E. Appendix

For example, the following configurations are acquired from the modes and embodiments described above.

A sound processing method according to one aspect (Aspect 1) includes: generating with a trained generative model, for each of a plurality of time points including a first time point, a first acoustic feature amount of a target sound to be generated, by sequentially processing input data including condition data representing conditions of the target sound; generating, for each of the plurality of time points, a time-domain waveform signal representing a waveform of the target sound based on the first acoustic feature amount; and generating, for each of the plurality of time points, a second acoustic feature amount based on the time-domain waveform signal, in which the input data at the first time point includes the second acoustic feature amount generated before the first time point.

In this aspect, a time-domain waveform signal is generated based on the first acoustic feature amount generated by the trained generative model, and the second acoustic feature amount of the waveform signal is returned to the input side of the generative model. That is, fluctuation factors associated with processing to generate the waveform signal from the first acoustic feature amount are reflected in the second acoustic feature amount, and the second acoustic feature amount is used by the generative model to generate the first acoustic feature amount. Therefore, a waveform signal of a target sound perceptually more natural as audio can be generated, as compared with a configuration in which the first acoustic feature amount is directly returned to the input side of the generative model.

The “target sound” means a sound targeted for generation by the sound processing method. For example, a musical sound such as a sound produced by playing a musical instrument or a singing sound produced by a singer is an example of the “target sound.” However, a voice such as a talking voice that does not include musical elements is also included in the concept of the “target sound.”

The “conditions of the target sound” are conditions that restrict the audio properties of the target sound. Specifically, various types of information including information such as a pitch or volume of a note constituting the target sound, information relating to notes before and after a note, or a feature of a sound output source of the target sound (for example, a musical instrument that produces the sound output, or a playing technique of a musical instrument) are “conditions of the target sound.” The condition data can be restated as a feature amount relating to a musical score (musical score feature amount) of the target sound.

The “generative model” is a learned model that learns a relation between the input data and the first acoustic feature amount through machine learning. For example, various types of statistical estimation models such as DNN, HMM, or SVM can be used as the “generative model.”

The “first acoustic feature amount” is an audio property of the target sound expressed in a frequency domain. For example, a frequency characteristic, such as a harmonic spectral envelope of the target sound and an inharmonic spectral envelope of the target sound, is an example of the “first acoustic feature amount.” The harmonic spectral envelope is a contour or a shape of an intensity spectrum (for example, an amplitude spectrum or a power spectrum) relating to harmonic components of the target sound. The harmonic components include a fundamental component of the fundamental frequency, and a plurality of overtone components within overtone frequencies corresponding to integer multiples of the fundamental frequency. The inharmonic spectral envelope is a contour or a shape of an intensity spectrum relating to inharmonic components of the target sound. The inharmonic components are noise components present between two harmonic components adjacent to each other in the frequency domain and contribute to the breathiness of the target sound. Various types of acoustic feature amounts, such as an amplitude spectrum, a power spectrum, MFSCs, MFCCs, and a mel-spectrum of the target sound are also included in the concept of the “first acoustic feature amount.”

The “waveform signal” is a time series of samples arranged on the time axis. The audio signal representing the waveform of the target sound is generated by coupling a plurality of waveform signals on the time axis.

The “second acoustic feature amount” is an audio property of the waveform signal expressed in the frequency domain. For example, the frequency characteristic such as the harmonic spectral envelope of the waveform signal and the inharmonic spectral envelope of the waveform signal are the “second acoustic feature amount.” Various types of acoustic feature amounts such as an amplitude spectrum, a power spectrum, MFSCs, MFCCs, and a mel-spectrum of the waveform signal are also included in the concept of the “second acoustic feature amount.”

The input data includes one or more second acoustic feature amounts generated with respect to time points prior to a first time point, which is the subject of the input data. For example, the input data includes a second acoustic feature amount generated with respect to a time point immediately before the first time point. The input data may include a plurality of second acoustic feature amounts generated with respect to different time points each prior to the first time point.

In a specific example (Aspect 2) according to Aspect 1, the first acoustic feature amount includes a harmonic spectral envelope relating to harmonic components of the target sound. In this aspect, the harmonic spectral envelope relating to the harmonic components of the target sound is generated by the generative model. Therefore, a waveform signal of the target sound including harmonic components perceptually natural as audio can be generated.

In a specific example (Aspect 3) according to Aspect 2, the first acoustic feature amount further includes phase information relating to the harmonic components of the target sound. In this aspect, the first acoustic feature (amount) includes phase information relating to the harmonic components of the target sound. Therefore, a higher quality waveform signal of the target sound can be generated compared with an approach in which the first acoustic feature amount does not include phase information. In a specific example (Aspect 4) according to Aspect 3, the phase information represents a phase spectral envelope.

In a specific example (Aspect 5) according to any one of Aspects 2 to 4, the generating of the time-domain waveform signal includes: generating a plurality of sine waves corresponding to different harmonic frequencies; generating a time-domain harmonic signal including the harmonic components of the target sound by (i) processing the plurality of sine waves so that levels of the plurality of sine waves follow the harmonic spectral envelope and (ii) synthesizing the processed plurality of sine waves; and generating the time-domain waveform signal using the time-domain harmonic signal. In this aspect, the harmonic signal can be easily generated by time-domain processing of the plurality of sine waves using the harmonic spectral envelope. Each of the “harmonic frequencies” is any of frequencies including the fundamental frequency and a plurality of overtone frequencies that are integer multiples of the fundamental frequency.

The processing of generating the harmonic signal is processing of bringing the level of a harmonic component corresponding to each of the harmonic frequencies to match or approximate the component value at the harmonic frequency in the harmonic spectral envelope. For example, the harmonic signal is generated by time-domain filtering processing. The response characteristics of the filtering processing are set to be response characteristics corresponding to the harmonic spectral envelope.

In a specific example (Aspect 6) according to Aspect 3 or 4, the generating of the time-domain waveform signal includes generating a harmonic signal including a plurality of sine waves corresponding to different harmonic frequencies, and the generating of the time-domain harmonic signal includes: adjusting levels of the plurality of sine waves in accordance with the harmonic spectral envelope; and adjusting phases of the plurality of sine waves in accordance with the phase information. In this aspect, the levels of the plurality of sine waves included in the harmonic signal are adjusted in accordance with the harmonic spectral envelope, and the phases of the sine waves are adjusted in accordance with the phase information. Therefore, a higher quality waveform signal of the target sound can be generated as compared with an approach in which only the levels of the sine waves are adjusted.

In a specific example (Aspect 7) according to Aspect 5 or 6, the generating of the time-domain waveform signal includes: receiving harmonic control data indicating an alteration to the harmonic spectral envelope; and altering the harmonic spectral envelope in accordance with the harmonic control data, and the generating of the time-domain harmonic signal generates the time-domain harmonic signal using the altered harmonic spectral envelope. In this aspect, since the harmonic spectral envelope is altered in accordance with the harmonic control data, the harmonic signal of diverse audio properties can be generated as compared with a configuration in which the harmonic spectral envelope is not altered. The harmonic signal is generated using the altered harmonic spectral envelope in accordance with the harmonic control data, and the second acoustic feature amount of the waveform signal generated based on the harmonic signal is returned to the input side of the generative model. That is, an alteration (one example of the fluctuation factors described above) of the harmonic spectral envelope in accordance with the harmonic control data is reflected in the generation of the first acoustic feature amount by the generative model. Therefore, a waveform signal of the target sound including a harmonic component perceptually more natural as audio can be generated as compared with a configuration in which the first acoustic feature amount is directly returned to the input side of the generative model.

The “harmonic control data” is any form of data that indicates an alteration to the harmonic spectral envelope. For example, data indicating emphasis or suppression of a specific peak in the harmonic spectral envelope or data indicating an increase or decrease of the component value of a specific frequency band in the harmonic spectral envelope is assumed as the “harmonic control data.” Data indicating whether to make an alteration to the harmonic spectral envelope is also an example of the “harmonic control data.”

The “alteration of the harmonic spectral envelope” is, for example, processing to alter the component value of the harmonic spectral envelope. For example, processing to increase or decrease the component value of a specific frequency band (for example, a band including a peak) of the harmonic spectral envelope or processing to increase or decrease the peak width in the harmonic spectral envelope is an example of the “alteration of the harmonic spectral envelope.”

In a specific example (Aspect 8) according to Aspect 7, the alteration of the harmonic spectral envelope includes suppressing, from among a plurality of peaks of the harmonic spectral envelope, a peak satisfying at least one of a condition where a maximum value is above a predetermined value or a condition where a peak width is below a predetermined value. In this aspect, excessively large or excessively steep peaks among the plurality of peaks of the harmonic spectral envelope are suppressed. Therefore, a waveform signal of the target sound including a harmonic component perceptually more natural as audio can be generated, as compared with a configuration in which excessively large or excessively steep peaks in the harmonic spectral envelope are maintained.

In a specific example (Aspect 9) according to any one of Aspects 5 to 8, the first acoustic feature amount includes a modulation spectral envelope relating to modulation components of the target sound. In this aspect, the modulation spectral envelope relating to the modulation components of the target sound is generated by the generative model. Therefore, a waveform signal of the target sound including the modulation components perceptually more natural as audio can be generated.

A “modulation component” is an audio component of a frequency having a predetermined relation to each of the harmonic frequencies of the harmonic components. For example, an audio component present between two harmonic components adjacent each other in the frequency domain corresponds to the “modulation component.” Specifically, the “modulation components” comprise an audio component located at a frequency away from a harmonic frequency to the high-frequency side, by the fundamental frequency divided by an integer, and an audio component located at a frequency away from the harmonic frequency to the low-frequency side, similarly by the fundamental frequency divided by an integer. For example, the modulation components are perceived as a growl voice included in the target sound.

In a specific example (Aspect 10) according to Aspect 9, the generating of the time-domain waveform signal includes: generating a basic modulation signal including a plurality of basic modulation components by subjecting the harmonic signal to amplitude modulation using a modulated wave at a frequency that has a predetermined relation to a fundamental frequency of the time-domain harmonic signal; generating a time-domain modulation signal including modulation components of the target sound by processing the basic modulation signal so that levels of the plurality of basic modulation components follow the modulation spectral envelope; and generating the time-domain waveform signal using the time-domain modulation signal. In this aspect, the waveform signal can be easily generated by amplitude modulation for generating the basic modulation signal from the harmonic signal and time-domain processing for processing the basic modulation signal using the modulation spectral envelope.

In a specific example (Aspect 11) according to Aspect 10, the generating of the time-domain waveform signal includes: receiving modulation control data indicating an alteration to the modulation spectral envelope; altering the modulation spectral envelope in accordance with the modulation control data; and the generating of the time-domain modulation signal generates the time-domain modulation signal using the altered modulation spectral envelope. In this aspect, since the modulation spectral envelope is altered in accordance with the modulation control data, a modulation signal of diverse audio properties can be generated as compared with a configuration in which the modulation spectral envelope is not altered. The modulation signal is generated using the altered modulation spectral envelope in accordance with the modulation control data, and the second acoustic feature amount of the waveform signal generated from the modulation signal is returned to the input side of the generative model. That is, an alteration (one example of the fluctuation factors described above) of the modulation spectral envelope in accordance with the modulation control data is reflected in the generation of the first acoustic feature amount by the generative model. Therefore, a waveform signal of the target sound including modulation components perceptually more natural as audio can be generated as compared with a configuration in which the first acoustic feature amount is directly returned to the input side of the generative mode.

The “modulation control data” is any form of data indicating an alteration to the modulation spectral envelope. For example, data indicating emphasis or suppression of a specific peak in the modulation spectral envelope or data indicating increase or decrease of the component value of a specific frequency band in the modulation spectral envelope is assumed as the “modulation control data.” Data indicating whether there is an alteration to the modulation spectral envelope is also the “modulation control data.”

The “alteration of the modulation spectral envelope” is, for example, processing to alter the component value of the modulation spectral envelope. For example, processing to increase or decrease the component value of a specific frequency band (for example, a band including a peak) in the modulation spectral envelope, or processing to increase or decrease the peak width in the modulation spectral envelope is an example of the “alteration of the modulation spectral envelope.”

In a specific example (Aspect 12) according to any one of Aspects 1 to 11, the first acoustic feature amount includes an inharmonic spectral envelope relating to inharmonic components of the target sound. In this aspect, the inharmonic spectral envelope relating to the inharmonic components of the target sound is generated by the generative model. Therefore, a waveform signal of the target sound including the inharmonic components perceptually more natural as audio can be generated.

In a specific example (Aspect 13) according to Aspect 12, the generating of the time-domain waveform signal includes: generating a time-domain noise signal having a flat frequency characteristic; generating a time-domain inharmonic signal that represents inharmonic components of the target sound by subjecting the noise signal to filtering processing to which an inharmonic spectral envelope is applied; and generating the time-domain waveform signal using the time-domain inharmonic signal. In this aspect, the waveform signal can be easily generated by time-domain filtering processing to which the inharmonic spectral envelope is applied.

In a specific example (Aspect 14) according to Aspect 13, the generating of the time-domain waveform signal includes: receiving inharmonic control data indicating an alteration to the inharmonic spectral envelope, and altering envelope in accordance with the inharmonic control data, and the generating of the time-domain inharmonic signal generates the time-domain inharmonic signal using the altered inharmonic spectral envelope. In this aspect, since the inharmonic spectral envelope is altered in accordance with the inharmonic control data, an inharmonic signal of diverse audio properties can be generated as compared with a configuration in which the inharmonic spectral envelope is not altered. The inharmonic signal is generated using the altered inharmonic spectral envelope in accordance with the inharmonic control data, and the second acoustic feature amount of the waveform signal generated from the inharmonic signal is returned to the input side of the generative model. That is, an alteration (one example of the fluctuation factors described above) of the inharmonic spectral envelope in accordance with the inharmonic control data is reflected in the generation of the first acoustic feature amount by the generative model. Therefore, a waveform signal of the target sound including inharmonic components perceptually more natural as audio can be generated as compared with a configuration in which the first acoustic feature amount is directly returned to the input side of the generative model.

The “inharmonic control data” is any form of data indicating an alteration to the inharmonic spectral envelope. For example, data indicating emphasis or suppression of a specific peak in the inharmonic spectral envelope or data indicating an increase or decrease of the component value of a specific frequency band in the inharmonic spectral envelope is assumed as the “inharmonic control data.” Data indicating whether to make an alteration to the inharmonic spectral envelope is also an example of the “inharmonic control data.”

The “alteration of the inharmonic spectral envelope” is, for example, processing to alter the component value of the inharmonic spectral envelope. For example, processing to increase or decrease the component value of a specific frequency band (for example, a band including a peak) in the inharmonic spectral envelope or processing to increase or decrease the peak width in the inharmonic spectral envelope is the “change of the inharmonic spectral envelope.”

In a specific example (Aspect 15) according to Aspect 1, the generating of the time-domain waveform signal generates the time-domain waveform signal by processing the first acoustic feature amount with a trained conversion model. The “conversion model” is a learned model that learns a relation between the first acoustic feature amount and the waveform signal by machine learning. For example, various types of statistical estimation models such as DNN, HMM, or SVM can be used as the “conversion model.”

A sound processing system according to one aspect (Aspect 16) includes: one or more memories storing instructions; and one or more processors configured to execute the stored instructions to: generate with a trained generative model, for each of a plurality of time points including a first time point, a first acoustic feature amount of a target sound to be generated, by sequentially processing input data including condition data representing conditions of the target sound; generate, for each of the plurality of time points, a time-domain waveform signal representing a waveform of the target sound based on the first acoustic feature amount; and generate, for each of the plurality of time points, a second acoustic feature amount based on the time-domain waveform signal, in which the input data at the first time point includes the second acoustic feature amount generated before the first time point.

A recording medium according to one aspect (Aspect 17) is a non-transitory computer-readable recording medium storing instructions executable by a processor to perform a method including: generating with a trained generative model, for each of a plurality of time points including a first time point, a first acoustic feature amount of a target sound to be generated, by sequentially processing input data including condition data representing conditions of the target sound; generating, for each of the plurality of time points, a time-domain waveform signal representing a waveform of the target sound based on the first acoustic feature amount; and generating, for each of the plurality of time points, a second acoustic feature amount based on the time-domain waveform signal, in which the input data at the first time point includes the second acoustic feature amount generated before the first time point.

### DESCRIPTION OF REFERENCE SIGNS

100 . . . sound processing system, 11 . . . control device, 12 . . . storage device, 121 . . . information retainer, 13 . . . sound emitting device, 14 . . . operation device, 21 . . . control data generator, 22 . . . sound processor, 31 . . . first generator, 32A, 32B . . . signal generator, 33 . . . second generator, 40 . . . harmonic signal generator, 41 . . . sine wave generator, 42 . . . harmonic characteristic alterer, 43 . . . harmonic signal synthesizer, 50 . . . inharmonic signal generator, 51 . . . basic signal generator, 52 . . . inharmonic characteristic alterer, 53 . . . inharmonic signal synthesizer, 60 . . . modulation signal generator, 61 . . . basic signal generator, 611 . . . modulated wave generator, 612 . . . amplitude modulator, 62 . . . modulation characteristic alterer, 63 . . . modulation signal synthesizer, 70 . . . signal mixer, 81 . . . frequency analyzer, 82 . . . learning processor, M1, M2 . . . generative model, Mc . . . conversion model.

1. A sound processing method realized by a computer system, the method comprising:
generating with a trained generative model, for each of a plurality of time points including a first time point, a first acoustic feature amount of a target sound to be generated, by sequentially processing input data including condition data representing conditions of the target sound;
generating, for each of the plurality of time points, a time-domain waveform signal representing a waveform of the target sound based on the first acoustic feature amount; and
generating, for each of the plurality of time points, a second acoustic feature amount based on the time-domain waveform signal,
wherein the input data at the first time point includes the second acoustic feature amount generated before the first time point.

2. The sound processing method according to claim 1, wherein the first acoustic feature amount includes a harmonic spectral envelope relating to harmonic components of the target sound.

3. The sound processing method according to claim 2, wherein the first acoustic feature amount further includes phase information relating to the harmonic components of the target sound.

4. The sound processing method according to claim 3, wherein the phase information represents a phase spectral envelope.

5. The sound processing method according to claim 2, wherein the generating of the time-domain waveform signal includes:
generating a plurality of sine waves corresponding to different harmonic frequencies;
generating a time-domain harmonic signal including the harmonic components of the target sound by (i) processing the plurality of sine waves so that levels of the plurality of sine waves follow the harmonic spectral envelope and (ii) synthesizing the processed plurality of sine waves; and
generating the time-domain waveform signal using the time-domain harmonic signal.

6. The sound processing method according to claim 3, wherein:
the generating of the time-domain waveform signal includes generating a harmonic signal including a plurality of sine waves corresponding to different harmonic frequencies, and
the generating of the time-domain harmonic signal includes:
adjusting levels of the plurality of sine waves in accordance with the harmonic spectral envelope; and
adjusting phases of the plurality of sine waves in accordance with the phase information.

7. The sound processing method according to claim 5, wherein:
the generating of the time-domain waveform signal includes:
receiving harmonic control data indicating an alteration to the harmonic spectral envelope; and
altering the harmonic spectral envelope in accordance with the harmonic control data, and
the generating of the time-domain harmonic signal generates the time-domain harmonic signal using the altered harmonic spectral envelope.

8. The sound processing method according to claim 7, wherein the alteration to the harmonic spectral envelope includes suppressing, from among a plurality of peaks of the harmonic spectral envelope, a peak satisfying at least one of a condition where a maximum value is above a predetermined value or a condition where a peak width is below a predetermined value.

9. The sound processing method according to claim 5, wherein the first acoustic feature amount includes a modulation spectral envelope relating to a modulation component of the target sound.

10. The sound processing method according to claim 9, wherein the generating of the time-domain waveform signal includes:
generating a basic modulation signal including a plurality of basic modulation components by subjecting the harmonic signal to amplitude modulation using a modulated wave at a frequency that has a predetermined relation to a fundamental frequency of the time-domain harmonic signal;
generating a time-domain modulation signal including modulation components of the target sound by processing the basic modulation signal so that levels of the plurality of basic modulation components follow the modulation spectral envelope; and
generating the time-domain waveform signal using the time-domain modulation signal.

11. The sound processing method according to claim 10, wherein:
the generating of the time-domain waveform signal includes:
receiving modulation control data indicating an alteration to the modulation spectral envelope;
altering the modulation spectral envelope in accordance with the modulation control data; and
the generating of the time-domain modulation signal generates the time-domain modulation signal using the altered modulation spectral envelope.

12. The sound processing method according to claim 1, wherein the first acoustic feature amount includes an inharmonic spectral envelope relating to inharmonic components of the target sound.

13. The sound processing method according to claim 12, wherein the generating of the time-domain waveform signal includes:
generating a time-domain noise signal having a flat frequency characteristic;
generating a time-domain inharmonic signal that represents inharmonic components of the target sound by subjecting the noise signal to filtering processing to which an inharmonic spectral envelope is applied; and
generating the time-domain waveform signal using the time-domain inharmonic signal.

14. The sound processing method according to claim 13, wherein:
the generating of the time-domain waveform signal includes:
receiving inharmonic control data indicating an alteration to the inharmonic spectral envelope, and
altering envelope in accordance with the inharmonic control data, and
the generating of the time-domain inharmonic signal generates the time-domain inharmonic signal using the altered inharmonic spectral envelope.

15. The sound processing method according to claim 1, wherein the generating of the time-domain waveform signal generates the time-domain waveform signal by processing the first acoustic feature amount with a trained conversion model.

16. A sound processing system comprising:
one or more memories storing instructions; and
one or more processors configured to execute the stored instructions to:
generate with a trained generative model, for each of a plurality of time points including a first time point, a first acoustic feature amount of a target sound to be generated, by sequentially processing input data including condition data representing conditions of the target sound;
generate, for each of the plurality of time points, a time-domain waveform signal representing a waveform of the target sound based on the first acoustic feature amount; and
generate, for each of the plurality of time points, a second acoustic feature amount based on the time-domain waveform signal,
wherein the input data at the first time point includes the second acoustic feature amount generated before the first time point.

17. A non-transitory computer-readable recording medium storing instructions executable by a processor to perform a method comprising:
generating with a trained generative model, for each of a plurality of time points including a first time point, a first acoustic feature amount of a target sound to be generated, by sequentially processing input data including condition data representing conditions of the target sound;
generating, for each of the plurality of time points, a time-domain waveform signal representing a waveform of the target sound based on the first acoustic feature amount; and
generating, for each of the plurality of time points, a second acoustic feature amount based on the time-domain waveform signal,
wherein the input data at the first time point includes the second acoustic feature amount generated before the first time point.
